(19) United States
(12) Patent Application Publication
(10) Pub. No.: US 2023/0358530 A1
(43) Pub. Date: Nov. 9, 2023

(54) CARRYING CASE SYSTEM FOR HANDHELD 3D SCANNER AND ITS ASSOCIATED CALIBRATION PLATE, AND METHOD OF USING SAME

(71) Applicant: CREAFORM INC., Levis (CA)

(72) Inventor: Nicolas Lebrun, Quebec (CA)

(21) Appl. No.: 18/311,301

(22) Filed: May 3, 2023

Related U.S. Application Data
(60) Provisional application No. 63/339,117, filed on May 6, 2022.

(51) Int. Cl. G01B 11/24

(52) U.S. Cl. CPC G01B 11/24

(57) ABSTRACT

A carrying case system for a handheld 3D scanner is presented for holding a handheld 3D scanner and associated calibration plate. The carrying case includes a main body with a lower body member defining a space for holding the 3D scanner, a protective frame member distinct from the lower body member for holding the calibration plate and a positioning system for mounting the protective frame member to the main body of the carrying case system in a selected one of a plurality of different calibration positions. The different calibration positions define respective inclination angles between the calibration plate and the main body. A method for using such a carrying case when calibrating a handheld 3D scanner is also presented.

### CROSS-REFERENCE TO RELATED APPLICATION

This application is being filed under 35 U.S.C. 111(a) and claims the benefit of priority under 35 USC § 119(e) based on U.S. provisional application Ser. No. 63/339,117, filed on May 6, 2022, and presently pending. The contents of the above-noted application are incorporated herein by reference.

### TECHNICAL FIELD

The present disclosure generally relates to the field of carrying case systems for measuring devices, and, more particularly, to carrying case systems for handheld three-dimensional (3D) scanners and associated calibration plates as well as methods of using same.

### BACKGROUND

Transportable measuring systems such as handheld scanners are used for accurately measuring 3D points on objects and recreating digital representations of 3D surfaces. For example, conventional handheld scanners comprise one or more optical components, or optical imaging modules, such as cameras, and light sources rigidly fixed with respect to each other (e.g., a camera stereo pair configuration), which may be used to scan objects. Specifically, scanning of a surface of an object may be achieved by moving a handheld scanner to several viewpoints of the object and capturing at each viewpoint a portion of the surface of the object with the imaging modules. The 3D measurements obtained from the different viewpoints are then combined using various techniques in order to create a digital 3D representation of the object.

Due to the inevitable changing of environmental conditions, as well as the nature of the optical components of the scanner, the measurement accuracy of the scanner is subject to drift over time which, if left uncorrected, may materially impact the accuracy of the data collected. To remedy this, calibration steps are periodically performed to reset the handheld scanner's optical parameters. Typically, such calibration steps include scanning a reference surface object, typically in the form of a substantially flat calibration plate, on which position reference markers have been placed in a known pattern. While for some applications it is generally not necessary to calibrate the scanner before every scan, it is nevertheless recommended that it be done on a regular basis in particular when the scanner is exposed to an obviously different environment than the last time it was calibrated.

Such handheld 3D scanners are generally costly and thus it is desirable to handle and transport them with care. Protecting the optical components is particularly important as they are relatively delicate, are often some of the more costly components of the scanner and are critical in providing precise and reliable scans. For that reason, carrying cases are typically provided to hold and transport such devices. Since it is desirable to also have the calibration plate on hand to be able to calibrate the scanner regularly, some carrying cases are equipped with compartments for also holding the calibration plate for easy access. In such cases, a separate protective casing may be provided for storing the calibration plate.

For optimal calibration, the handheld scanner typically needs to orient its scanning direction at specific angles/orientations and distances with reference to the surface of the calibration plate to collect data points which are used to calibrate the scanner. In some specific applications, this involves first scanning the surface of the calibration plate in a scanning direction orthogonal to the surface of the calibration plate while translating the scanner closer and/or further at pre-established distances from the calibration plate. In this manner, a translation displacement of the scanner is performed while maintaining an orthogonal scanning direction. Following this, as a next step, while keeping the distance between the scanner and the surface of the calibration plate substantially constant, the scanning direction is varied by performing a partial rotation of the scanner about the calibration plate so that the scanning direction and the surface of the calibration plate form varying angles during the scan. In some cases, to assist with the positioning and displacements of the scanner during the calibration process, some software tools are provided to present a dynamically adaptable visual depiction of the actual scanner position relative to the calibration plate along with information to guide the operator to a desired position and/or displacement for the scanner.

Holding the scanner while performing a translation is generally relatively easy to do for an operator. However, holding the scanner while performing a partial rotation about the calibration plate to position it at a correct desired angle while maintaining a substantially constant distance from the surface of the calibration plate is significantly more challenging and often requires some practice. Moreover, some of the arm movements required to perform such a partial rotation of the scanner necessitate a certain amount of upper body strength and may cause muscle strain for the operator.

Another deficiency with commonly used calibration plates and methods for using them is that the calibration plates typically need to be removed from their protective casing (when one is provided) when they are used during calibration. In less clean and/or outdoor environments, such as for example in a pipeline dirt hole, a refinery with an oily floor or a metal welding shop, it is not convenient to have to remove the calibration plate from its protective casing as it may get damages and be rendered useless for its intended purpose.

Against the background described above, it is clear that there remains a need in the industry to provide improved carrying case systems for handheld three-dimensional (3D) scanners and associated calibration plates that alleviate at least some of the deficiencies of conventional handheld 3D scanners.

### SUMMARY

This summary is provided to introduce a selection of concepts in a simplified form that are further described below in the Detailed Description. This Summary is not intended to identify all key aspects and/or essential aspects of the claimed subject matter.

In accordance with some general aspects of this disclosure, there is provided a carrying case system for a 3D scanner and a calibration plate, the carrying case system comprising:
a) a main body comprising a lower body member defining a space for holding the 3D scanner;
b) a protective frame member distinct from the lower body member of the main body for holding the calibration plate;
c) a positioning system configured for mounting the protective frame member to the main body of the carrying case system in a selected one of a plurality of different calibration positions, wherein the plurality of different calibration positions define respective inclination angles between the calibration plate and the main body, the plurality of different calibration positions including at least two distinct calibration positions for using the calibration plate during calibration of the 3D scanner.

In some practical implementations, the positioning system may be configured for mounting the protective frame member to the lower body member of the main body in the selected one of the plurality of different calibration positions. The respective inclination angles between the calibration plate and the main body correspond to inclination angles between the calibration plate and the lower body member of the main body.

In some practical implementations, the main body may further comprise an upper body member distinct from the lower body member, wherein the upper body member and the lower body member are configured to releasably engage one another to define an internal storage space for holding the 3D scanner and the calibration plate. In such embodiments, the protective frame member may be configured to be positioned within the internal storage space defined by the upper body member and the lower body member of the main body. The upper body member may be configured to be releasably connected to the lower body member and the internal storage space defined by the upper body member and the lower body member maybe either a partially enclosed internal storage space or a fully enclosed internal storage space.

In some alternative practical implementations, the positioning system may be configured for mounting the protective frame member to the upper body member of the main body in the selected one of the plurality of different calibration positions, wherein the respective inclination angles between the calibration plate and the main body correspond to inclination angles between the calibration plate and the upper body member of the main body.

The positioning system may take different forms in specific practical examples of implementation.

In a first example, the positioning system may be implemented at least in part by a first positioning surface of the main body, a second positioning surface of the main body and the at least one frame mounting surface on the protective frame member. For example, in some implementations, the first positioning surface may define a first, relatively small angle with the bottom surface of the main body or may be substantially parallel to the bottom surface of the main body and the second positioning surface may define a second angle with the bottom surface of the lower member, wherein the second angle is larger than the first angle between the first positioning surface and the bottom surface of the main body. The first positioning surface may correspond to a first calibration position in the plurality of calibration positions and the second positioning surface may correspond to a second calibration position in the plurality of calibration positions.

In a second example of positioning systems, the positioning system may include a hinged member disposed opposite a calibration surface of the calibration plate. The hinged member may be configured to be mounted on at least one of the lower body and the upper body members and may be extendible so as to position the calibration plate in a selected one of the plurality of different calibration positions.

It will be appreciated that many other alternative embodiments for the positioning system may be contemplated by the person skilled in the art in view of the present description.

In some practical implementations, the plurality of different calibration positions may include a first specific calibration position defining a first specific inclination angle between 0° and 45°; preferably between 0° and 20°; more preferably between 0° and 10°. In a very specific implementation, the first specific inclination angle may be about 0° so that the calibration plate is substantially co-planar with lower body member of the main body.

In some practical implementations, the plurality of different calibration positions may include a second specific calibration position defining a second specific inclination angle between 5° and 75°; preferably between 5° and 50°; more preferably between 10° and 40°; more preferably between 15° and 30°; preferably between 15° and 25°. In a very specific implementation, the second specific inclination angle is about 20°. It is also to be appreciated that while the above examples have discussed two different calibration positions, it is to be appreciated that alternative embodiment may include three, four or more different calibration positions.

In some practical implementations, the positioning system may be further configured for mounting the protective frame member to the lower body member of the main body in a storage position distinct from the calibration positions in the plurality of different calibration positions. In a specific example, the calibration plate may include a first substantially flat calibration surface on which a set of markers are positioned in a specific pattern and a second surface opposed to the first surface. In the storage position, the calibration surface of the calibration plate may be at least partially (or in other cases fully) concealed from a user of the 3D scanner by the carrying case system. In the plurality of different calibration positions, the calibration surface of the calibration plate may be substantially unobstructed by the carrying case system. In some very specific implementations, in the storage position, the protective frame may be configured for holding the calibration plate in an orientation that is substantially co-planar with the lower body member.

The main body of the carrying case system may be comprised are a variety of materials. The selection of specific materials may provide some advantages to the carrying case system.

In some specific examples, the main body may be comprised of a lightweight material. For example, the lightweight material may include cardboard and/or foam. In practical implantations, foam may be preferred as it tends to be more durably and more easily manipulated to create certain specific shapes. Various types of foam materials may be used, such as for example, expanded polystyrene (EPS) foam and Expanded Polypropylene (EPP) foam. In a very specific implementations, the foam used for the main body includes Expanded Polypropylene (EPP) foam. Advantageously, the use of Expanded Polypropylene (EPP) provides a main body that may have a desirable level of energy absorption, impact resistance, thermal insulation, buoyancy, water and chemical resistance. Other advantages include high strength to weight ratio and 100% recyclability.

Optionally, in some implementations, the carrying case system may comprise an outer protective shell including an upper outer shell and a lower outer shell, wherein the upper shell is configured to be at least partially releasably connected to the lower shell. The upper shell and a lower shell define an internal space configured for holding therein the main body of the carrying case system. Some implementations, the upper shell may be hingedly connected to the lower shell. The protective shell may be comprised are various types of materials depending on desired characteristics for the protective shell. The materials used may include soft material (such as various types of fabrics for example) as well as rigid materials (such a hard plastic material and/or a metallic material). The outer protective shell may be equipped with various convenience components such as, without being limited to, one or more wheels mounted to the outer protective shell to assist in displacing the carrying case system; and one or more handles on the outer protective shell for facilitating transport of the carrying case system by a user.

In some specific examples, the space for holding the 3D scanner defined by the lower body member may include a first cavity for holding the 3D scanner and, in some cases, a second cavity for holding cable components associated with the 3D scanner, wherein the cable components include at least one of a power cable and a data cable. In very specific embodiments, the first cavity may be shaped to substantially match a shape of the 3D scanner and the second cavity may have an elongated shape for receiving the wiring components. In the first and second cavities may be joined with one another or, alternatively, may be substantially distinct from one another.

In accordance with other general aspects of this disclosure, there is provided a carrying case system for a 3D scanner and a calibration plate, the carrying case system comprising:
a. a protective frame member for holding the calibration plate;
b. a main body comprising:
   i. a lower body member defining a first cavity for holding the 3D scanner;
   ii. an upper body member distinct from the lower body member, wherein the upper body member and the lower body member are configured to releasably engage one another to define an internal storage space;
wherein the protective frame member is configured to be positioned within the internal storage space defined by the upper body member and the lower body member of the main body.

In some specific implementations, the protective frame member may be configured for lying above the first cavity defined by the lower body member. In some cases, a positioning system may be provided configured for mounting the protective frame member to the lower body member so that the calibration plate lies over the cavity defined by the lower body member.

In some specific implementations, the lower body member may define a second cavity for holding cable components associated with the 3D scanner, wherein the cable components include at least one of a power cable and a data cable.

Practical specific examples of carrying case systems of the type described above may be configured for various types of 3D scanners having various shapes including handheld 3D scanners.

In accordance with other general aspects of this disclosure, there is provided a method for calibrating a handheld 3D scanner using a calibration plate and a carrying case system of the type described above. The method comprises the steps of:
a. mounting the protective frame member holding the calibration plate to the main body of the carrying case system in a first calibration position defining a first inclination angle between the calibration plate and the main body;
b. using the handheld 3D scanner to perform a first scanning event of the calibration plate while the protective frame member holding the calibration plate is mounted in the first calibration position, the first scanning event including performing a first translation movement of the handheld 3D scanner to vary a distance between the handheld 3D scanner and the calibration plate;
c. mounting the protective frame member holding the calibration plate to the main body of the carrying case system in a second calibration position defining a second inclination angle between the calibration plate and the main body;

d. using the handheld 3D scanner to perform a second scanning event of the calibration plate while the protective frame member holding the calibration plate is mounted in the second calibration position, the second scanning event including performing a second translation movement of the handheld 3D scanner to vary a distance between the handheld 3D scanner and the calibration plate;
e. processing data obtained during the first scanning event and the second scanning event to calibrate the handheld 3D scanner.

In some specific implementations, a first scanning orientation relative to the main body of the carrying case system may be associated with the first scanning event and a second scanning orientation relative to the main body of the carrying case system may be associated with the second scanning event. In some practical implementations, the first scanning orientation and the second scanning orientation relative to the main body of the carrying case system are substantially similar.

All features of exemplary embodiments which are described in this disclosure and are not mutually exclusive can be combined with one another. Elements of one embodiment or aspect can be utilized in the other embodiments/aspects without further mention. These and other aspects of this disclosure will now become apparent to those of ordinary skill in the art upon review of a description of embodiments that follows in conjunction with accompanying drawings.

### BRIEF DESCRIPTION OF THE DRAWINGS

The above-mentioned features and objects of the present disclosure will become more apparent with reference to the following description taken in conjunction with the accompanying drawings, wherein like reference numerals denote like elements and in which:

FIG. 1 is a schematic view of a handheld 3D scanner in accordance with an specific implementation in the process of scanning a surface of a target object;

FIG. 2 is a perspective view of the handheld 3D scanner of FIG. 1;

FIG. 3 is an exploded view of a casing system configured to store, transport, protect and facilitate the use of the handheld 3D scanner of FIG. 1 in accordance with a specific example of implementation of the invention;

FIGS. 4 to 10 are views of the casing system of FIG. 3 shown is a storage position including respectively: a perspective view (FIG. 4); a top plan view (FIG. 5); a bottom plan view (FIG. 6); a right-side elevation view (FIG. 7); a front elevation view (FIG. 8); a left-side elevation view (FIG. 9); and a rear elevation view (FIG. 10);

FIGS. 11 to 18 are views of the casing system of FIG. 3 shown in a first calibration position with an upper body member removed from the casing system, the views including respectively: an exploded view (FIG. 11); a perspective view (FIG. 12); a top plan view (FIG. 13); a bottom plan view (FIG. 14); a right-side elevation view (FIG. 15); a front elevation view (FIG. 16); a left-side elevation view (FIG. 17); and a rear elevation view (FIG. 17);

FIGS. 19 to 26 are views of the casing system of FIG. 3 shown in a second calibration position with an upper body member removed from the casing system, the views including respectively: an exploded view (FIG. 19); a perspective view (FIG. 20); a top plan view (FIG. 21); a bottom plan view (FIG. 22); a right-side elevation view(Fig. 23); a front elevation view (FIG. 24); a left-side elevation view (FIG. 25); and a rear elevation view (FIG. 26);

FIGS. 27 to 34 are views of the casing system of FIG. 3 including an protective shell in according with a specific embodiment, the views including respectively: an exploded view (FIG. 27); a perspective view with the protective shell in an open position (FIG. 28); a top plan view with the protective shell in an open position (FIG. 29); a bottom plan view with the protective shell in an open position (FIG. 30); a right-side elevation view with the protective shell in an open position (FIG. 31); a front elevation view with the protective shell in an open position (FIG. 32); a left-side elevation view with the protective shell in an open position (FIG. 33); and a rear elevation view with the protective shell in an open position (FIG. 34);

FIG. 35 is a perspective view of the casing system of FIG. 3 including the protective shell of FIG. 27 with the protective shell in a closed position;

FIG. 36 shows a top view of a calibration plate for calibrating the handheld 3D scanner of FIGS. 1 and 2 in accordance with a non-limiting example;

FIG. 37 is a block diagram showing a method of calibrating the scanner of FIGS. 1 and 2 in according with a specific embodiment;

FIGS. 38A and 38B schematically show rotation scanning events for calibrating a scanner of the type shown in FIGS. 1 and 2;

FIG. 39A schematically shows a first translation scanning event for calibrating a scanner of the type shown in FIGS. 1 and 2;

FIG. 39B schematically shows a third translation scanning event for calibrating a scanner of the type shown in FIGS. 1 and 2;

FIG. 40A schematically shows a second translation scanning event for calibrating a scanner of the type shown in FIGS. 1 and 2;

FIG. 40B schematically shows a fourth translation scanning event for calibrating a scanner of the type shown in FIGS. 1 and 2;

FIG. 41 is a top view of a protective frame of a casing system holding a calibration plate according to a first variant;

FIG. 42 is a right-side elevation view of part of a casing system including the protective frame according to the variant of FIG. 41, wherein the casing system is in a first calibration position;

FIG. 43 is a right-side elevation view of part of the casing system including the protective frame according to the variant of FIG. 41, wherein the casing system is in a second calibration position;

FIG. 44 is a right-side elevation view of part of a casing system according to a second variant, wherein the casing system is in a first calibration position;

FIG. 45 is a right-side elevation view of the part of the casing system of FIG. 44, wherein the casing system is in a second calibration position;

FIG. 46 is a bottom view of part of a casing system according to a third variant comprising at least one wedge;

FIG. 47 is a perspective view of the wedge of the casing system shown in FIG. 46;

FIG. 48 is a right-side elevation view of the part of the casing system of FIG. 46, wherein the casing system is in a first calibration position;

FIG. 49 is a right-side elevation view of the part of the casing system of FIG. 46, wherein the casing system is in a second calibration position;

FIG. 50 is a perspective view of a protective frame of the casing system according to a fourth variant comprising at least one hinge and a flap, wherein the flap is in a first position;

FIG. 51 is a perspective view of the protective frame of the casing system of FIG. 50, wherein the flap is in a second position;

FIG. 52 is a right-side elevation view of part of the casing system of FIG. 50, wherein the casing system is in a first calibration position; and

FIG. 53 is a right-side elevation view of the part of the casing system of FIG. 50, wherein the casing system is in a first calibration position.

In the drawings, embodiments are illustrated by way of example. It is to be expressly understood that the description and drawings are only for purposes of illustrating certain embodiments and are an aid for understanding. They are not intended to be a definition of the limits of the invention.

### DETAILED DESCRIPTION OF EMBODIMENTS

A detailed description of one or more specific embodiments of the invention is provided below along with accompanying Figures that illustrate principles of the invention. The invention is described in connection with such embodiments, but the invention is not limited to any specific embodiment. It is to be appreciated that the embodiments described are being provided only for the purpose of illustrating the inventive principles and should not be considered as limiting. The scope of the invention is limited only by the claims. Numerous specific details are set forth in the following description in order to provide a thorough understanding of the invention. These details are provided for the purpose of describing non-limiting examples and the invention may be practiced according to the claims without some or all of these specific details. For the purpose of clarity, technical material that is known in the technical fields related to the invention has not been described in great detail so that the invention is not unnecessarily obscured.

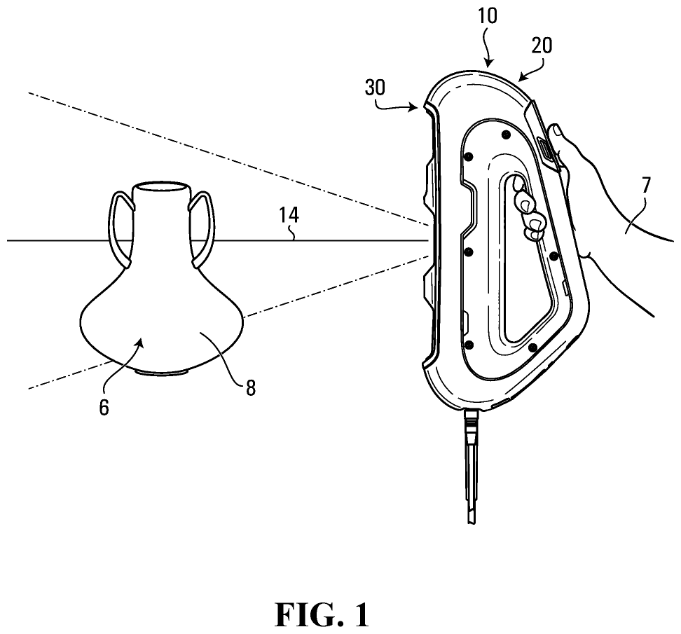

FIG. 1 shows an embodiment of a handheld scanner 10, i.e., a scanner that is holdable in one or two hands, for scanning a target object 6 and generating 3D data 12 relating to a surface 8 of the target object 6. The scanner 10 comprises a frame structure 20 imparting stiffness to the scanner 10, and one or more imaging modules 30 affixed to the frame structure 20 for scanning the surface 8 of the target object 6. The scanner 10 also includes one or more processors (not shown in FIG. 1) positioned within an interior of frame structure 20 and operatively connected to the one or more imaging modules 30. The one or more processors may be configured for receiving and processing data generated by the one or more imaging modules 30 during scanning. The one or more processors may also be configured for controlling the one or more imaging modules 30 to generate the data in accordance with any suitable method. Various suitable methods for controlling imaging components and for processing data generated by such components are known to persons of skill in the art and will therefore not be described in further detail here.

As depicted in FIG. 1, during use, the scanner 10 may have a scanning direction 14 and the imaging modules 30 are configured to scan surface towards the scanning direction 14.

As further described below, the frame structure 20 may be ergonomically configured to facilitate its manipulation by a user and allow a user to easily scan a surface from different viewpoints and orientations.

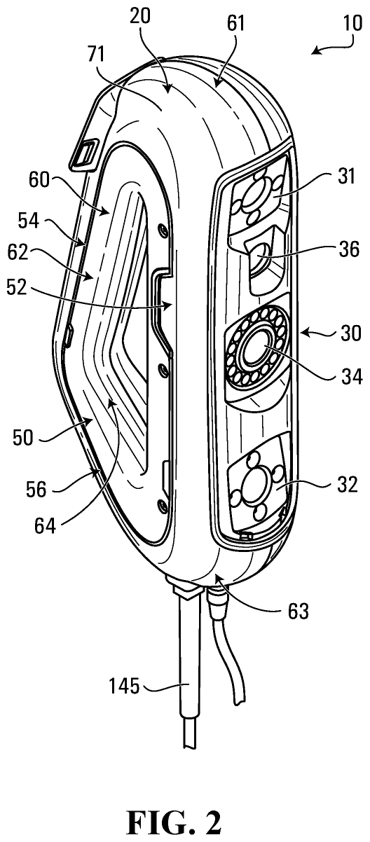

In some embodiments, the scanner 10 may have an overall shape 10 that is configured to increase a stiffness of the scanner 10 and facilitate manipulation of the scanner 10 by a user. The overall shape of the scanner 10 may, for example, be defined by a shape of an outer periphery 19 of the frame structure 20. The outer periphery 19 of the frame structure may have any suitable overall shape, such as, for example: a generally polygonal shape (e.g. a generally triangular shape, a generally trapezoidal shape, a generally hexagonal shape, a generally octagonal shape or other generally polygonal shape etc. . . . ); a half-moon shape; a crescent shape, and the like. More particularly, in the embodiment depicted in FIGS. 1 and 2, the outer periphery 19 of the frame structure 20 has a generally triangular shape.

The set of imaging modules 30 in the handheld 3D scanner include at least one camera however in some practical embodiments, the scanner may also include one or mode additional cameras and one or more pattern generators including one or more light sources.

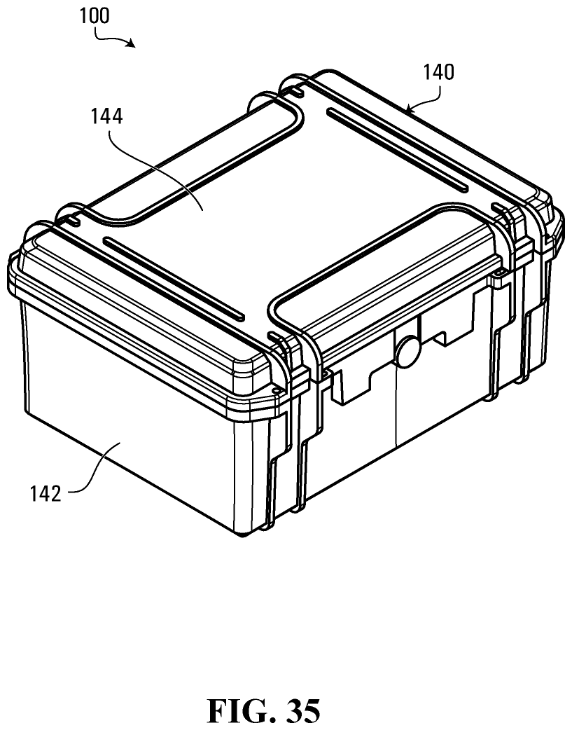

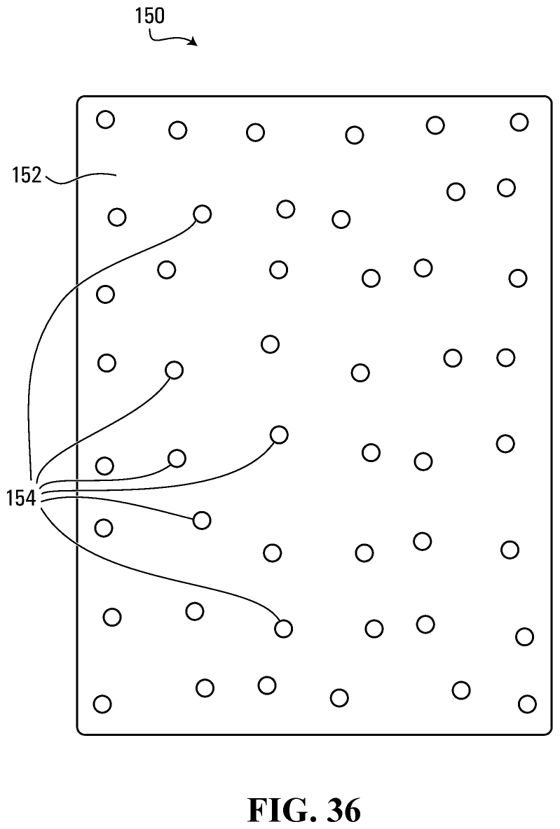

As shown in FIG. 36, to maintain an accuracy of the handheld scanner 10 over time and use, a calibration plate 150 may be provided for calibrating the handheld scanner 10 by following a pre-determined calibration method. In this embodiment, the calibration plate 150 is substantially flat and comprises a calibration surface 152 and a second surface opposed to the calibration surface 152. A set of position reference markers 154 may be positioned in a specific, pre-determined fashion on the calibration surface 152 of the calibration plate 150. In particular, the position reference markers 154 may be positioned on the calibration surface 152 of the calibration plate in a known pattern. It is to be appreciated that the calibration plate 150 depicted in FIG. 35 is shown for the purpose of illustration and that calibration plates used in practical implementations may differ. While for some applications it may not be necessary to calibrate the scanner 10 before every scan, it is recommended that the scanner 10 be calibrated on a regular basis, in particular when the scanner 10 is exposed to an obviously different environment than the last time it was calibrated.

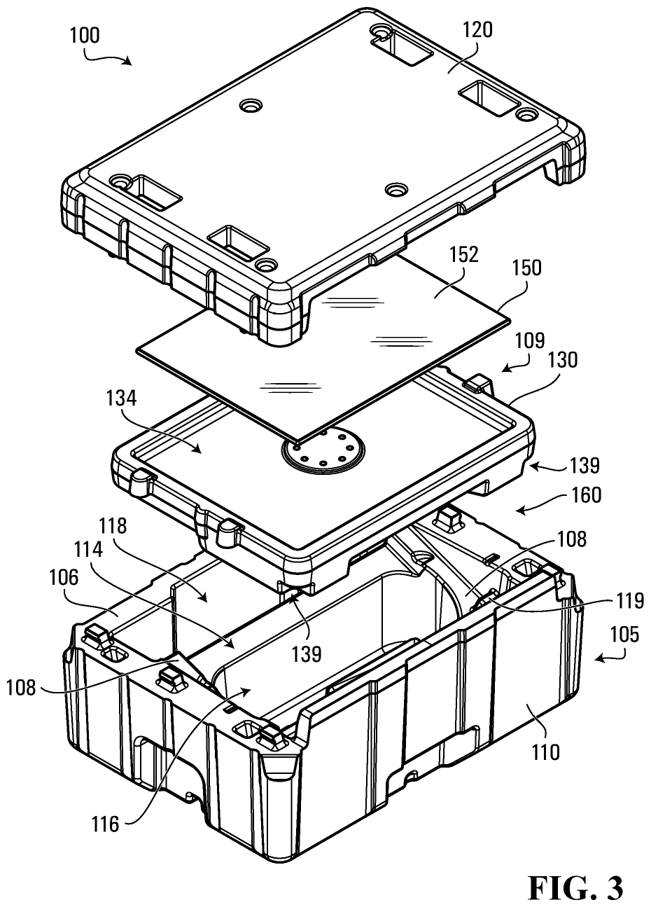

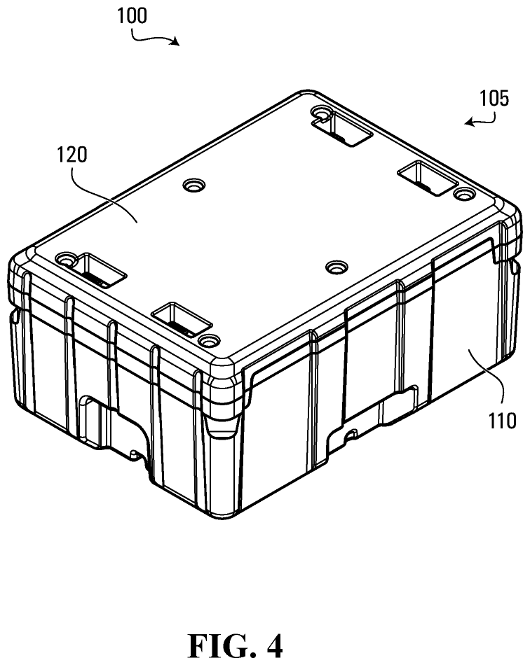

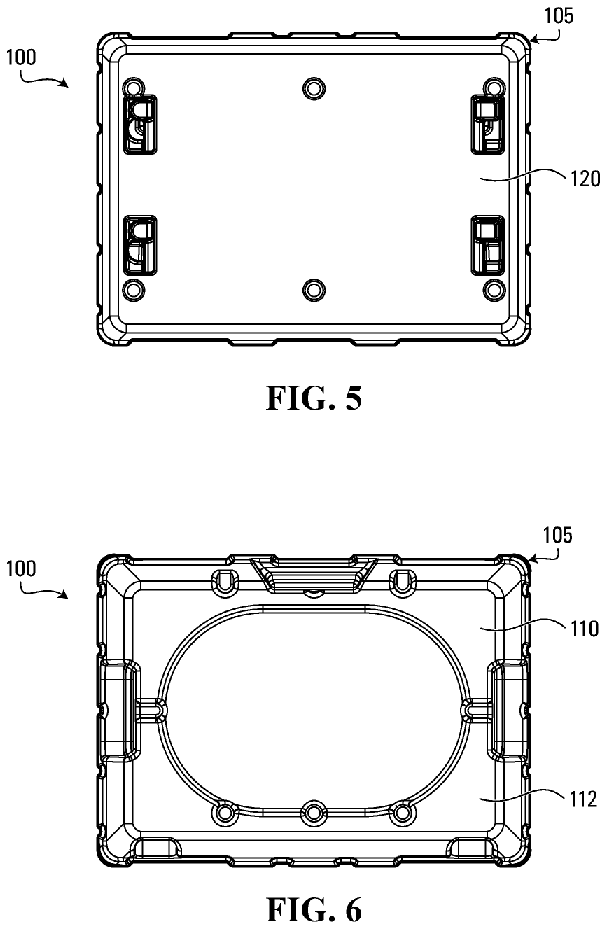

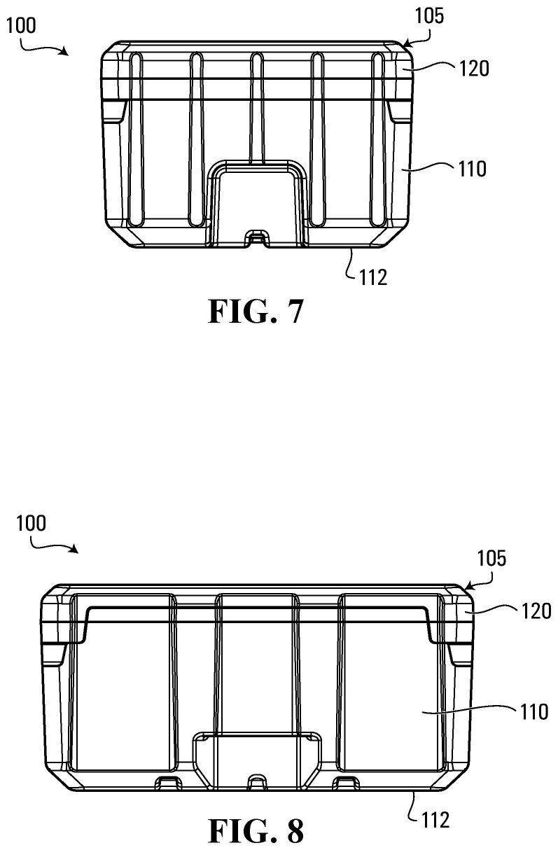

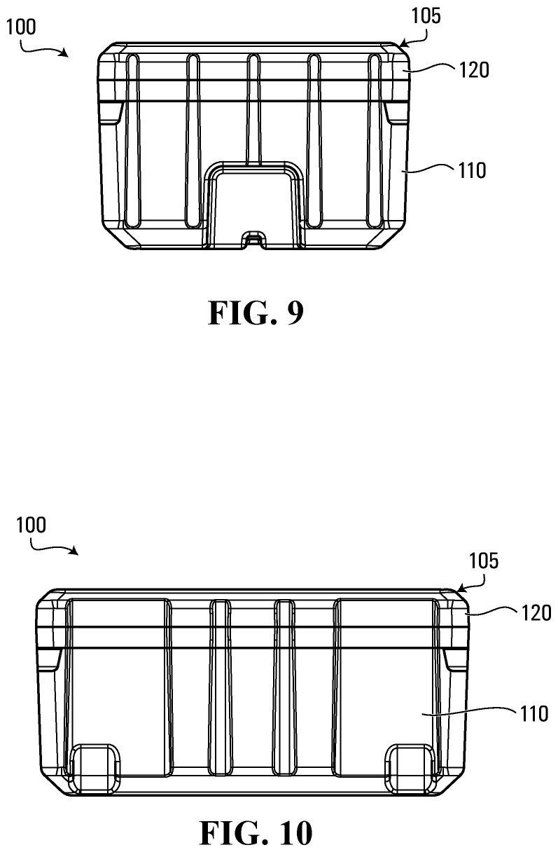

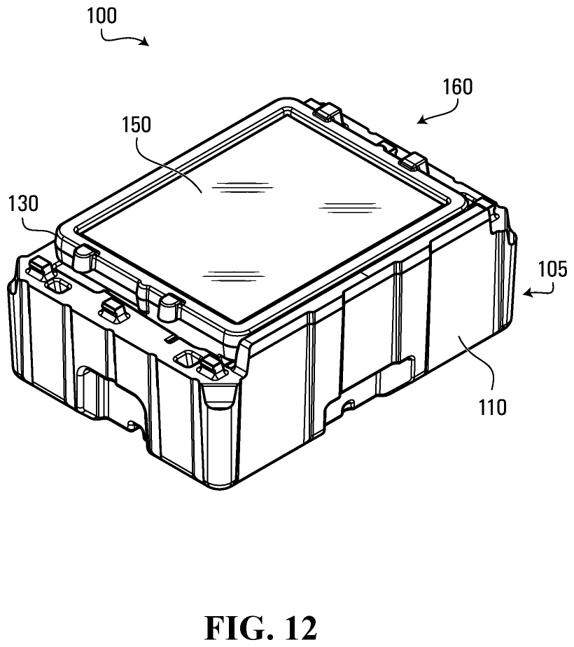

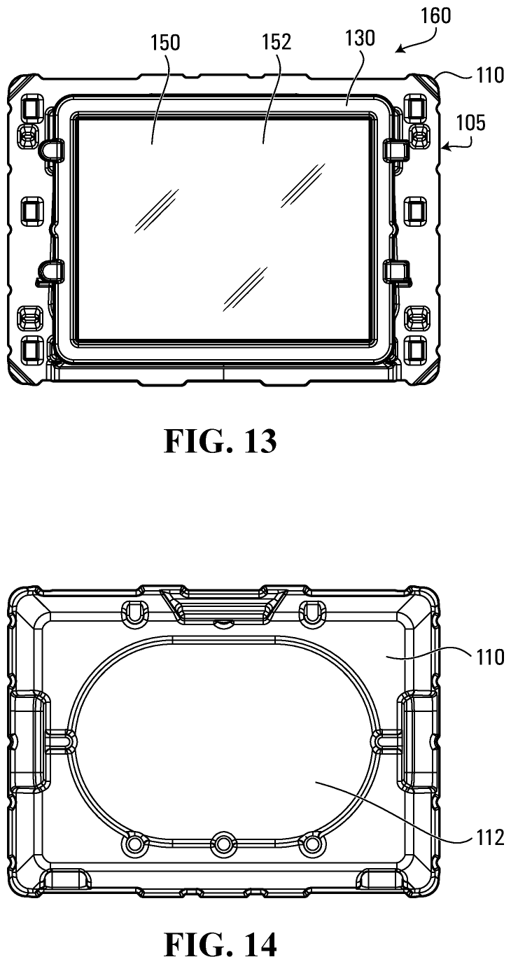

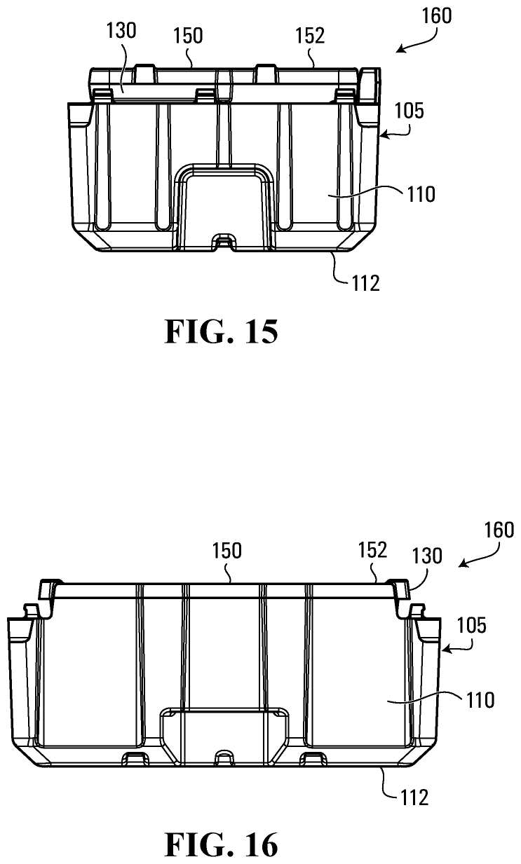

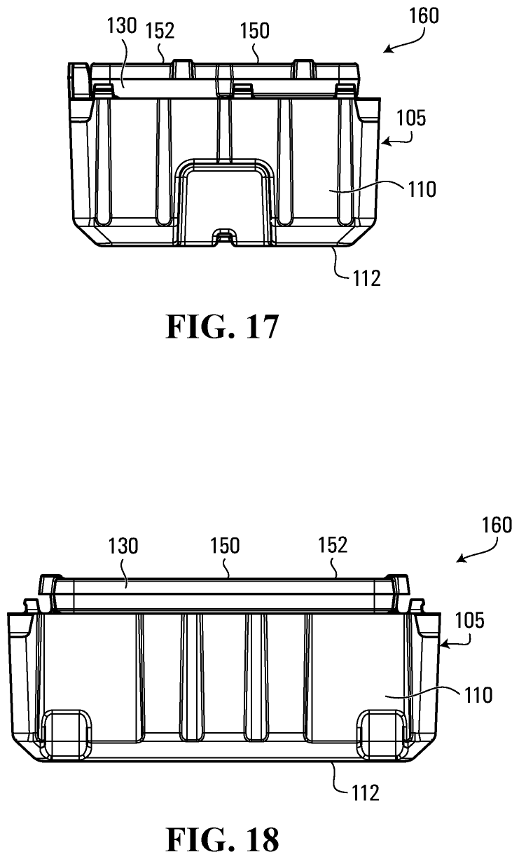

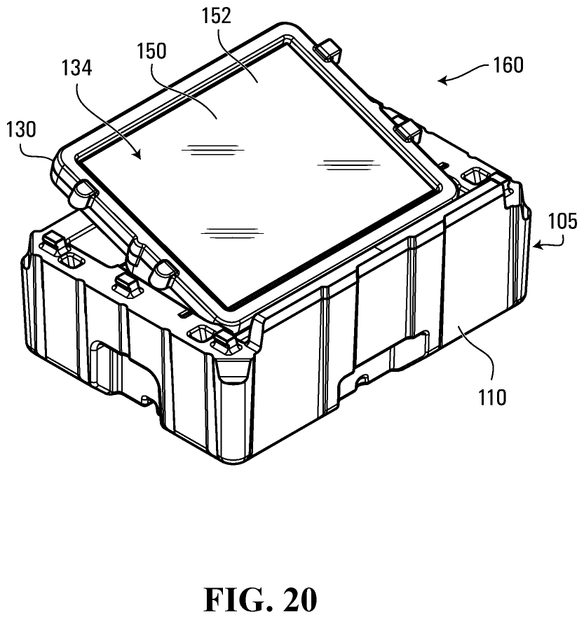

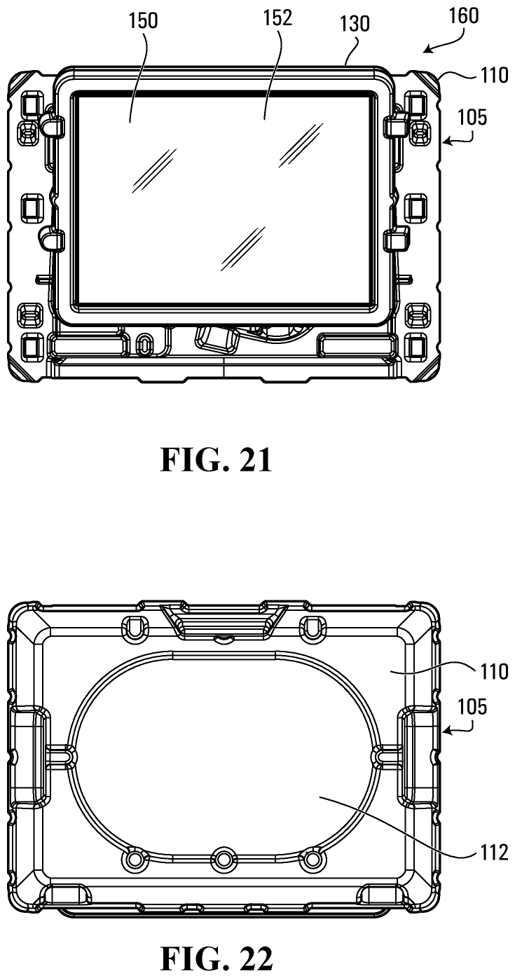

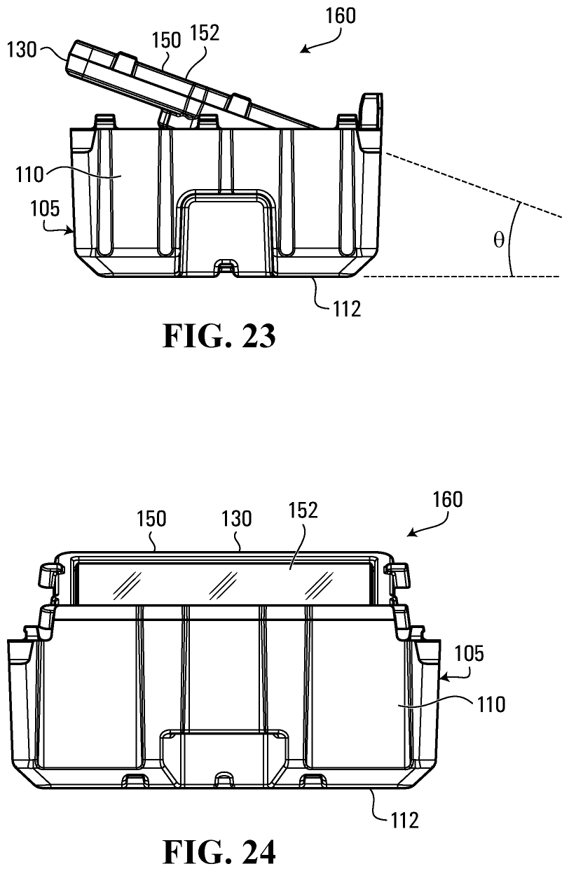

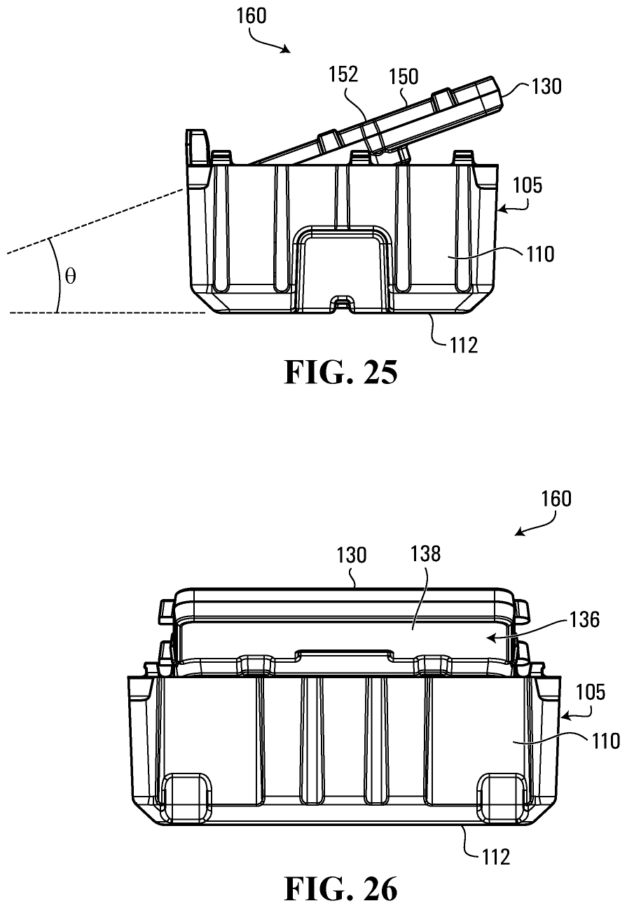

As will be described below, a carrying case system is provided for carrying the 3D scanner and its calibration plate. FIGS. 3 to 26 depict a first example of implementation of a carrying case system 100 according to the present disclosure. As depicted, the carrying case system 100 may be configured for storing, transporting and/or protecting the handheld 3D scanner 10 and the calibration plate 150. The carrying case system 100 may also be configured for positioning the calibration plate 150 in at least two orientations while performing a calibration process for handheld 3D scanner 10.

As depicted in FIGS. 3 to 10, the carrying case system 100 may comprise a main body 105 including a lower body member 110 defining a space 114 for holding the 3D scanner 10 and (optionally) scanner components. More specifically, as illustrated in the Figures, the space 114 may include a first cavity 116 for holding the scanner 10 and a second cavity 118 distinct from the first cavity 114. The second cavity 118 may be shaped to receive scanner components such as, for example, wiring components 11 associated with the scanner 10. In this example, the second cavity 118 has a generally elongated shape. The first cavity 116 may be shaped to substantially match a shape of the scanner 10. The wiring components 11 may comprise cable components which may include at least one of (i.e., one of, a plurality of or all of) a power cable and a data cable. In some embodiments, the first and second cavities 116, 118 may be configured for receiving other scanner accessories 13 such as boxes containing positioning reference marker replacements, USB memory sticks, international power adapter plugs, batteries, memory cards, etc. Alternatively, additional cavities may be provided in the space 114 in the lower body member 110 for receiving these components.

As depicted in FIGS. 3 to 10, the main body 105 may also comprise an upper body member 120 distinct from the lower body member 110. The upper body member 120 and the lower body member 110 are configured to releasably engage one another to define an internal storage space 109 therebetween for holding the 3D scanner 10 and the calibration plate 150. More particularly, in this example, the internal storage space 109 defined when the upper body member 120 and the lower body member 110 are engaged with one another is a fully enclosed internal storage space. In this embodiment, the periphery of the upper body member 120 may be configured to be releasably connected to the periphery of lower body member 110.

The main body 105 of the carrying case system 100 may comprise a bottom surface 112 configured to support the main body 105 (e.g., on a ground surface, on a desk surface, etc.) and defining an orientation of the main body 105. In this embodiment, the bottom surface 112 is an outer surface of the lower body member 110 of the main body 105.

The carrying case system 100 may also comprise a protective frame member 130 distinct from the lower body member 110 for holding the calibration plate 150. The protective frame member 130 is configured to hold the calibration plate 150 and protect the calibration plate 150, e.g., from impacts. In some embodiments, the protective frame member 130 may be configured to reduce or delay the occurrence of deformations of the calibration plate 150 which may occur over time and/or use of the calibration plate 150.

As depicted in FIGS. 3 to 26, the protective frame member 130 is configured to be positioned within the internal storage space 114 defined by the upper body member 120 and the lower body member 110 of the main body 105. For instance, the protective frame member 130 may be configured for lying above the first cavity 116 defined in the lower body member 110 and, in some implementations, for lying within an inner periphery of the lower body member 110. The protective frame member 130 may comprise a first side 134 configured to receive the calibration plate 150 and a second side 136 opposite the first side 134 for mounting and positioning the protective frame member 130 upon the upper body member 120 and the lower body member 110 of the main body 105 of the carrying case system 100. In this embodiment, the protective frame member 130 is configured so that the calibration plate 150 remains visible when received by the protective frame member 130 on the first side 134 of the protective frame member 130.

As depicted in FIGS. 3 to 26, the carrying case system 100 may also comprise a positioning system 160 configured for mounting the protective frame member 130 to the main body 105 of the carrying case system 100 in a selected one of a plurality of different possible calibration positions. In the plurality of different calibration positions, the calibration surface 152 of the calibration plate 150 is substantially unobstructed by the components of the carrying case system 100, and the different calibration positions define respective inclination angles θ between the calibration plate 150 and the main body 105. More specifically, as shown in FIGS. 3 to 26, the different calibration positions may define respective inclination angles θ between the calibration plate 150 and a bottom surface of the main body 105. More specifically, the plurality of different calibration positions may include two or more distinct calibration positions for using the calibration plate 150 during calibration of the 3D scanner 10.

As depicted in FIGS. 3 to 26, the positioning system 160 may be configured for mounting the protective frame member 130 to the lower body member 110 of the main body 105 in a selected one of the plurality of different calibration positions, and the respective inclination angles θ are inclination angles between the calibration plate 150 and the lower body member 110 of the main body 105. In alternative embodiments (not shown in FIGS. 3 to 26), the positioning system 160 may be configured for mounting the protective frame member 130 to the upper body member 120 of the main body 105 in the selected one of the plurality of different calibration positions, and the respective inclination angles θ may be inclination angles between the calibration plate 150 and the upper body member 120 of the main body 105.

The positioning system 160 may include a first set of positioning elements on the protective frame 130 and a second set of positioning elements on the main body 105 (e.g., on the lower member 110 or on the upper member 120). The second set of positioning elements may be complementary to the first set of positioning elements.

In this embodiment, the first set of positioning elements on the protective frame 130 forms a frame mounting surface 138 disposed on the protective frame 130. More specifically, the frame mounting surface 138 may be about a periphery of the protective frame 130, more specifically on the second side 136 of the protective frame 130. In some embodiments, the frame mounting surface 138 may comprise at least two distinct mounting surface portions each configured for engaging the main body 105 in a respective distinct manner to orient the calibration plate 150 in a selected one of the plurality of different possible calibration positions. In some embodiments, the frame mounting surface 138 may comprise at least three distinct mounting surface portions and, in some embodiments, even more (e.g., at least four distinct mounting surface portions).

The second set of positioning elements may form at least two positioning surfaces 106, 108 on the main body 105. More specifically, in this embodiment, the positioning surfaces 106, 108 may be formed on the lower member 110 of the main body 105, more specifically on an inner periphery of the lower member 110 of the main body 105. The at least two positioning surfaces 106, 108 may be complementary to the frame mounting surface 138 on the protective frame 130 so that the positioning surfaces 106, 108 can selectively engage the frame mounting surface 138 on the protective frame 130. More specifically, in this embodiment, each of the at least two positioning surfaces 106, 108 may be complementary with one of the distinct mounting surface portions of the frame mounting surface 138 so that the positioning surfaces 106, 108 can selectively engage one of the distinct mounting surface portions of the frame mounting surface 138 on the protective frame 130.

As depicted in FIGS. 3 to 26, each of the first and second positioning surfaces 106, 108 may form a distinct angle with the bottom surface 112 of the main body 105 so that when the the protective frame member 130 is mounted thereto, the calibration plate 150 attached to the protective frame member 130 is oriented according to a specific one of the plurality of different calibration positions.

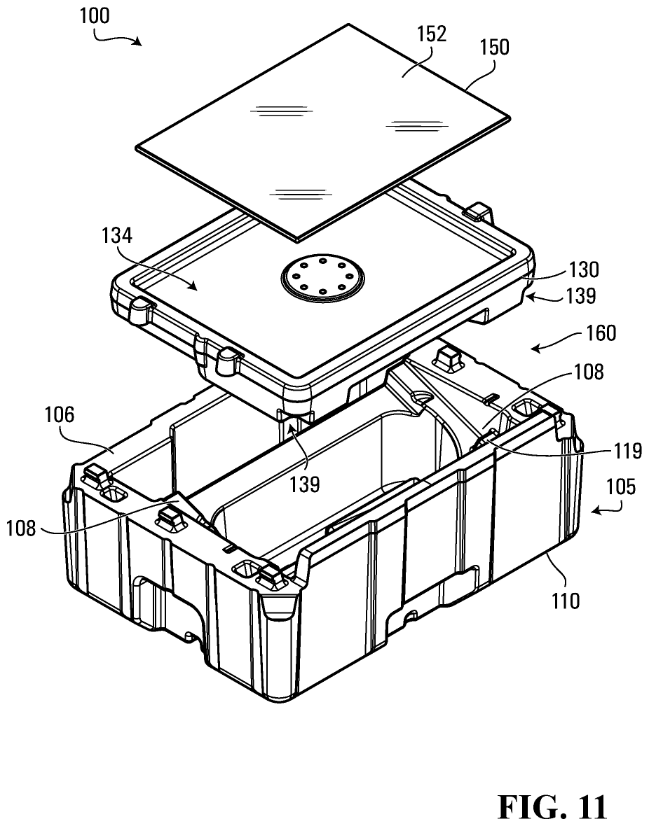

For instance, the first positioning surface 106 may define a first, relatively small angle with the bottom surface 112 of the main body 105 or may be substantially parallel with the bottom surface 112 of the main body 105. In a first one of the plurality of different calibration positions, illustrated in FIGS. 11 to 18, one of surface portions forming a first frame mounting surface on the second side 136 of the protective frame member 130 may engage and rest upon the first positioning surface 106. To maintain the protective frame member 130 in the first calibration position, the positioning system 160 may, in some implementations, additionally comprise complementary projections and recesses provided on respective ones of the protective frame member 130 and the lower member 110 of the main body 105 and configured to engage one another when the protective frame member 130 is configured in the first calibration position.

In the first calibration position depicted in FIGS. 11 to 18, the calibration plate 150 may define a first inclination angle θ with bottom surface 112 of the lower member 110. In some embodiments, the first inclination angle θ may be between 0° and 45°, in some embodiments between 0° and 20°, in some embodiments between 0° and 10°, and in some embodiments between 0° and 5°. More specifically, as depicted in FIGS. 11 to 18, the first inclination angle θ is about 0° so that the calibration plate 150 is substantially parallel with the bottom surface 112 of the lower member 110. That is, when the bottom surface 112 of the lower member 110 rests on a horizontal surface, in the first calibration position, the plate 150 is substantially horizontal.

In this embodiment, the first positioning surface 106 on the lower member 110 defines at least part of a periphery of the storage space 114. In particular, at least part of the first positioning surface 106 is configured to releasably engage the upper member 120 of the main body 105 when the members 110, 120 of the main body 105 are engaged with one another.

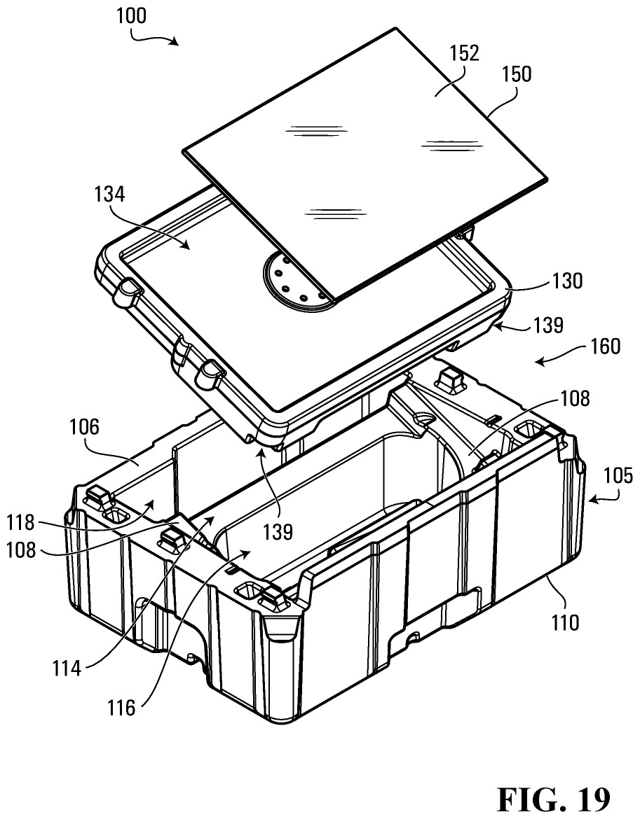

In the embodiment depicted in FIGS. 3 to 26, the second positioning surface 108 defines a second inclination angle with the bottom surface 112 of the lower member 110 that is larger than the first inclination angle between the first positioning surface 106 and the bottom surface 112 of the main body 105. In a second one of the calibration positions, illustrated in FIGS. 19 to 26, the frame mounting surface 138 of the second side 136 of the protective frame member 130 may engage and rest upon the second positioning surface 108. To maintain the protective frame member 130 in the second calibration position, the positioning system 160 may, in some implementations, additionally comprise complementary projections and recesses provided on respective ones of the protective frame member 130 and the lower member 110 of the main body 105 wherein the complementary projections and recesses are configured to engage one another when the protective frame member 130 is in the second one of the calibration positions. For instance, as depicted in the embodiment of FIGS. 3 to 26, the frame member 130 may comprise recesses 139 on the second side 136 of the frame member 130 and the lower body member 110 of the main body 105 may comprise projections 119 projecting from the second positioning surface 108. The projections 119 configured to engage the recesses 139 of the frame member 130 to releasably hold the frame member 130 in the second calibrating position.

In the second calibration position, illustrated in FIGS. 19 to 26, the calibration plate 150 may define a second inclination angle θ with bottom surface 112 of the lower member 110. In some embodiments, the second inclination angle θ may be between 5° and 75°, in some embodiments between 5° and 50°, in some embodiments between 10° and 40°, in some embodiments between 15° and 30°, in some embodiments between 15° and 25°, and in some embodiments about 20°.

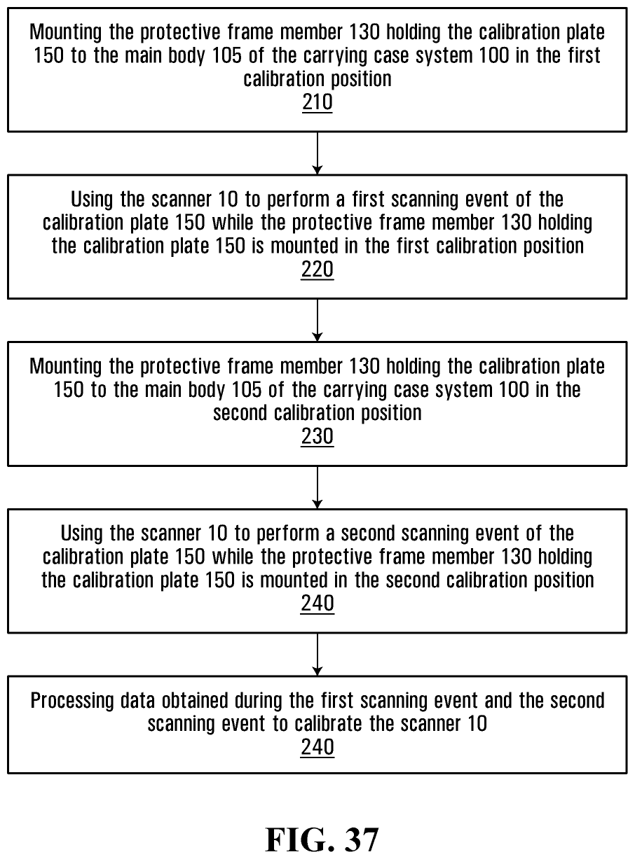

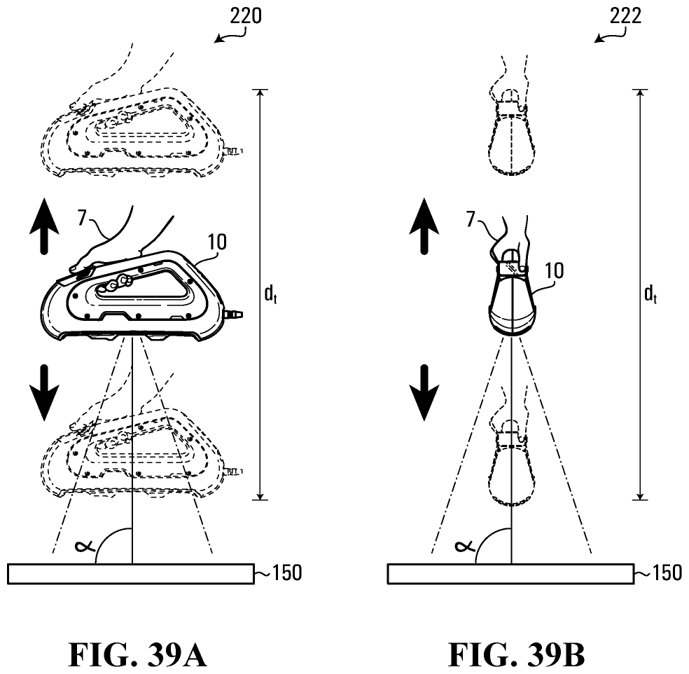

The plurality of different calibration positions of the calibration plate 150 provided by the carrying case system 100 depicted in FIGS. 3 to 26 may advantageously allow a facilitating calibration of the scanner 10. In particular, by providing a plurality of different calibration positions, scanning movements required by necessitate less upper body strength and/or may reduce or avoid muscle strain for the operator. For instance, as shown in FIG. 37, in some embodiments in which the plurality of different calibration positions includes first and second calibrating positions of the calibration plate 150 of the type described above, a calibration process may advantageously provide the method comprising the following steps:
Step 210: Mounting the protective frame member 130 holding the calibration plate 150 to the main body 105 of the carrying case system 100 in the first calibration position defining the first inclination angle θ between the calibration plate 150 and the bottom surface 112 of the main body 105 (as shown in FIGS. 11 to 18).
Step 220: Using the scanner 10 to perform a first scanning event of the calibration plate 150 while the protective frame member 130 holding the calibration plate 150 is mounted in the first calibration position. The first scanning event may include performing a first translation movement of the scanner 10 in the scanning direction 14 to vary a distance between the scanner 10 and the surface 152 of the calibration plate 150. The first translation movement may cover a translation distance dₜ. For instance, in some embodiments, the translation distance dₜ may be between 30 mm and 500 mm, in some embodiments between 30 mm and 400 mm, in some embodiments between 30 mm and 300 mm, in some embodiments between 30 mm and 200 mm, and in some embodiments between 30 mm and 100 mm. In some embodiments, the first translation movement may be performed in a plurality of substeps, during which respective portions of the first translation movement are performed. Between each substep, the first translation movement may be paused for a pre-determined duration. For instance, in this embodiment, the first translation may be performed in at least 2 substeps, in some embodiments in at least 3 substeps, in some embodiments in at least 4 substeps, in some embodiments in at least 5 sub steps, and in some embodiments even more (e.g., at least 6 substeps). During the first translation movement, an angle a may be maintained between the scanning direction 14 and the calibration surface 152 of the calibration plate 150. In this example, when the bottom surface 112 rests on a horizontal surface, the scanning direction 14 and the first translation movement may be substantially vertical, the calibration surface 152 may be substantially horizontal, and the angle a may be between 70° and 110°, in some embodiments between 80° and 100°, and in some embodiments may be about 90°. An example of step 220 is illustrated in FIG. 39B.

Step 230: Mounting the protective frame member 130 holding the calibration plate 150 to the main body 105 of the carrying case system 100 in the second calibration position defining the second inclination angle θ between the calibration plate 150 and the bottom surface 112 of the main body 105 (as shown in FIGS. 19 to 26).

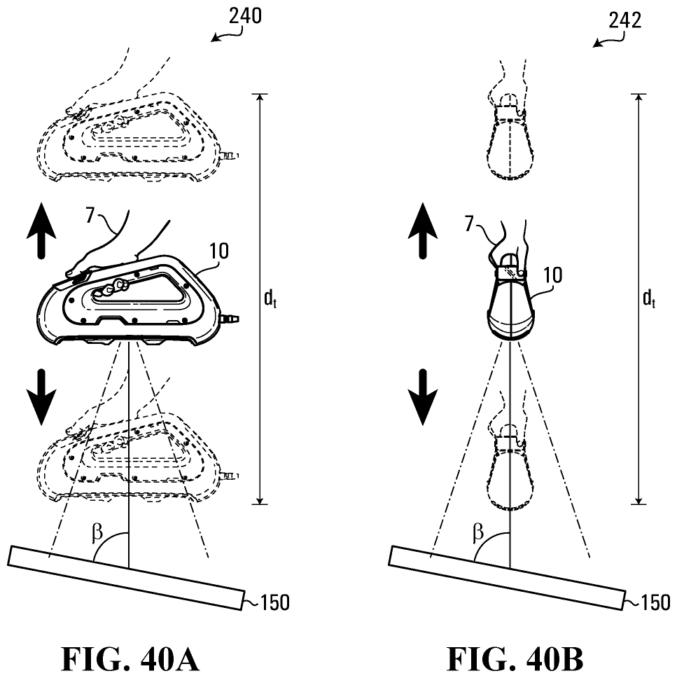

Step 240: Using the scanner 10 to perform a second scanning event of the calibration plate 150 distinct and different from the first scanning event while the protective frame member 130 holding the calibration plate 150 is mounted in the second calibration position. The second scanning event may include performing a second translation movement of the scanner 10 in the scanning direction 14 to vary a distance between the scanner 10 and the surface 152 of the calibration plate 150. The second translation movement may cover the translation distance dₜ. In some embodiments, the second translation movement may be performed in a plurality of substeps, during which respective portions of the first translation movement are performed. Between each substep, the second translation movement may be paused for a pre-determined duration. For instance, in this embodiment, the second translation may be performed in at least 2 substeps, in some embodiments in at least 3 substeps, in some embodiments in at least 4 substeps, in some embodiments in at least 5 substeps, and in some embodiments even more (e.g., at least 6 sub steps). During the second translation movement, an angle β may be maintained between the scanning direction 14 and the calibration surface 152 of the calibration plate 150. In this example, when the bottom surface 112 rests on a horizontal surface, the scanning direction 14 and the second translation movement may be substantially vertical, the calibration surface 152 may be oriented at an angle of about 20° with a horizontal plane, and the angle β may be between 50° and 90°, and in some embodiments may be about 70°. An example of step 240 is illustrated in FIG. 40A.
Step 250: Processing data obtained during the first scanning event and the second scanning event to calibrate the scanner 10. Any suitable known approach may be used to calibrate the scanner based on the data obtained.

In some embodiments, the method may also comprise the steps of: (i) associating the first calibration position with a first scanning orientation relative to the bottom surface 112 of the main body 105, with the angle a and/or with the first scanning event; and (ii) associating the second calibration position with a second scanning orientation relative to the main body 105, with the angle β and/or with the second scanning event. More specifically, in this embodiment, the first scanning orientation and the second scanning orientation relative to the bottom surface 112 of the main body 105 of the carrying case system 100 are substantially similar and may be between 70° and 110°, in some embodiments between 80° and 100°, and in some embodiments may be about 90°.

In some embodiments, the method may also comprise the steps of:
Step 222: Using the scanner 10 to perform a third scanning event of the calibration plate 150 distinct and different from the first scanning event while the protective frame member 130 holding the calibration plate 150 is mounted in the first calibration position. The third scanning event may include performing a third translation movement of the scanner 10 in the scanning direction 14 to vary a distance between the scanner 10 and the surface 152 of the calibration plate 150. The third scanning event and the third translation movement may be similar to the first scanning event and the first translation movement, except that an initial orientation of the scanner 10 may be different. For instance, in this embodiment, the scanner 10 is rotated by a pre-determined angle (e.g., about)90° from an initial position of the first scanning event to achieve the initial position of the third scanning event. The third translation movement may cover the translation distance dₜ. In some embodiments, the third translation movement may be performed in a plurality of substeps, during which respective portions of the third translation movement are performed. Between each sub step, the third translation movement may be paused for a pre-determined duration. For instance, in this embodiment, the third translation may be performed in at least 2 substeps, in some embodiments in at least 3 substeps, in some embodiments in at least 4 substeps, in some embodiments in at least 5 substeps, and in some embodiments even more (e.g., at least 6 substeps). During the third translation movement, the angle α may be maintained between the scanning direction 14 and the calibration surface 152 of the calibration plate 150. In this example, when the bottom surface 112 rests on a horizontal surface, the scanning direction 14 and the third translation movement may be substantially vertical, the calibration surface 152 may be substantially horizontal, and the angle a may be between 70° and 110°, in some embodiments between 80° and 100°, and in some embodiments may be about 90°. An example of step 222 is illustrated in FIG. 39B. For instance, in some embodiments, the step 222 may be performed between steps 220 and 230.
Step 242: Using the scanner 10 to perform a fourth scanning event of the calibration plate 150 distinct and different from the first, second and third scanning events while the protective frame member 130 holding the calibration plate 150 is mounted in the second calibration position. The fourth scanning event may include performing a fourth translation movement of the scanner 10 in the scanning direction 14 to vary a distance between the scanner 10 and the surface 152 of the calibration plate 150. The fourth canning event and the fourth translation movement may be similar to the second scanning event and the second translation movement, except that an initial orientation of the scanner 10 may be different. For instance, in this embodiment, the scanner 10 is rotated by a pre-determined angle (e.g., about 90°) from an initial position of the second scanning event to achieve the initial position of the fourth scanning event. The fourth translation movement may cover the translation distance dₜ. In some embodiments, the fourth translation movement may be performed in a plurality of substeps, during which respective portions of the first translation movement are performed. Between each substep, the fourth translation movement may be paused for a pre-determined duration. For instance, in this embodiment, the fourth translation may be performed in at least 2 substeps, in some embodiments in at least 3 substeps, in some embodiments in at least 4 substeps, in some embodiments in at least 5 substeps, and in some embodiments even more (e.g., at least 6 sub steps). During the fourth translation movement, the angle may be maintained between the scanning direction 14 and the calibration surface 152 of the calibration plate 150. In this example, when the bottom surface 112 rests on a horizontal surface, the scanning direction 14 and the fourth translation movement may be substantially vertical, the calibration surface 152 may be oriented at an angle of about 20° with a horizontal plane, and the angle R may be between 50° and 90°, and in some embodiments may be about 70°. An example of step 242 is illustrated in FIG. 40B. For instance, in some embodiments, the step 242 may be performed between steps 240 and 250.

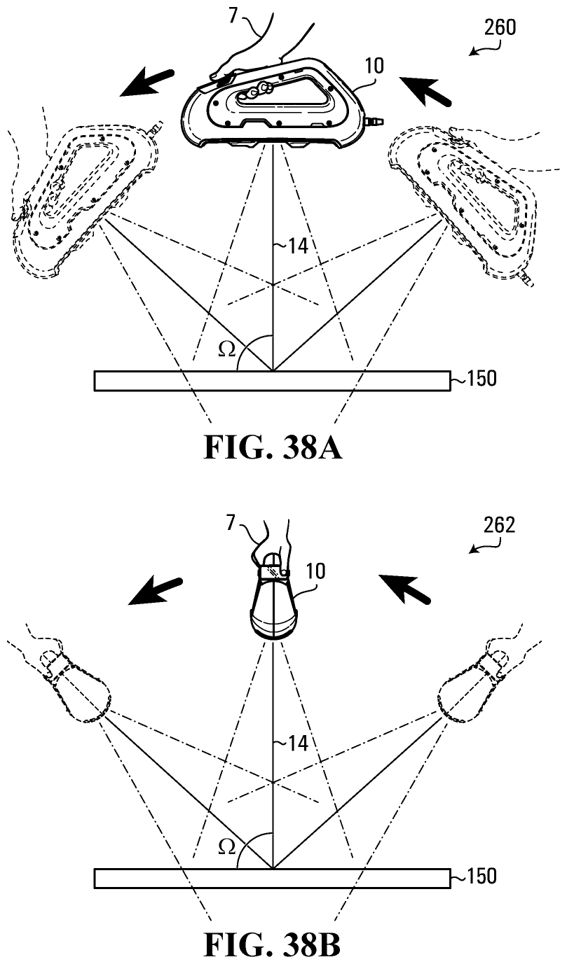

In this embodiment, the method may allow a calibration of the scanner 10 without requiring steps 260, 262 of using the scanner 10 to perform a rotation scanning event of the calibration plate 150 while the protective frame member 130 holding the calibration plate 150 is mounted in one of the first and second calibration positions. In particular, the rotation scanning event may include performing a rotation movement of the scanner 10 about the calibration surface 152 to vary an angle Ω between the scanning direction 14 of the scanner and the surface 152 of the calibration plate 150. During the rotation movement, distance may be maintained between the scanner 10 and the calibration surface 152 of the calibration plate 150. Examples of steps 260, 262 are illustrated in FIGS. 38A and 38B. The plurality of different calibration positions of the calibration plate 150 provided by the carrying case system 100 depicted in FIGS. 1 to 26 advantageously may reduce and in some cases eliminate the need to perform such a rotation movement during a calibration scan.

With additional reference to FIGS. 3 to 10, the positioning system 160 the positioning system may be further configured for mounting the protective frame member 130 to the lower body member 110 of the main body 105 in a storage position distinct from the plurality of different calibration positions. In the storage position, the calibration surface 152 of the calibration plate 150 may be at least partially concealed from the user of the 3D scanner 10 by the carrying case system 100. More particularly, in this example, the calibration surface 152 of the calibration plate 150 may be concealed from the user of the 3D scanner 10 by the main body 105 of the carrying case system 100.

In this embodiment, in the storage position, the protective frame 130 may be configured for holding the calibration plate 150 in an orientation that is substantially parallel with the lower body member 110. More specifically, in the storage position, the protective frame 130 may be configured for holding the calibration plate 150 so that the frame mounting surface 138 of the second side 136 of the protective frame member 130 and the calibration plate 150 are substantially parallel with the bottom surface 112 of the lower member 110.

The components of the carrying case system 100 may be constructed using various suitable materials. In some embodiments, the main body 105 may be comprised a suitable lightweight material, such as, for example, cardboard and foam. When foam is used, in some cases, the foam may be selected from the set consisting of: expanded polystyrene (EPS) foam, expanded Polypropylene (EPP) foam and any combination thereof. An advantage of using EPP foam is that is provides protection for the scanner 10 (impact protection, thermal insulation and other). EPP is also resistant to water, making this material useful in conditions of high humidity as it may allow the carrying case system 100 to maintain its mechanical properties.

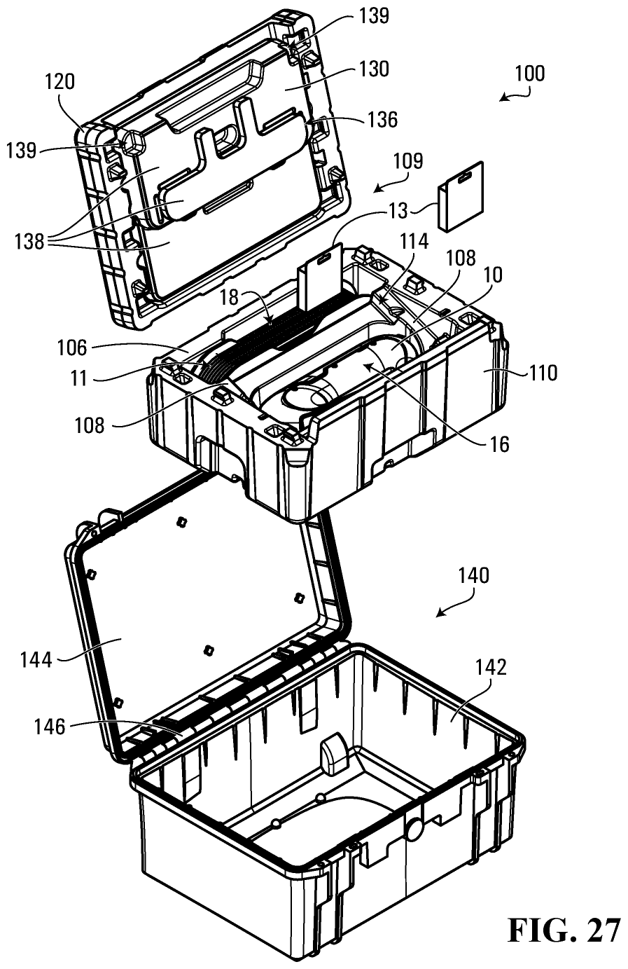

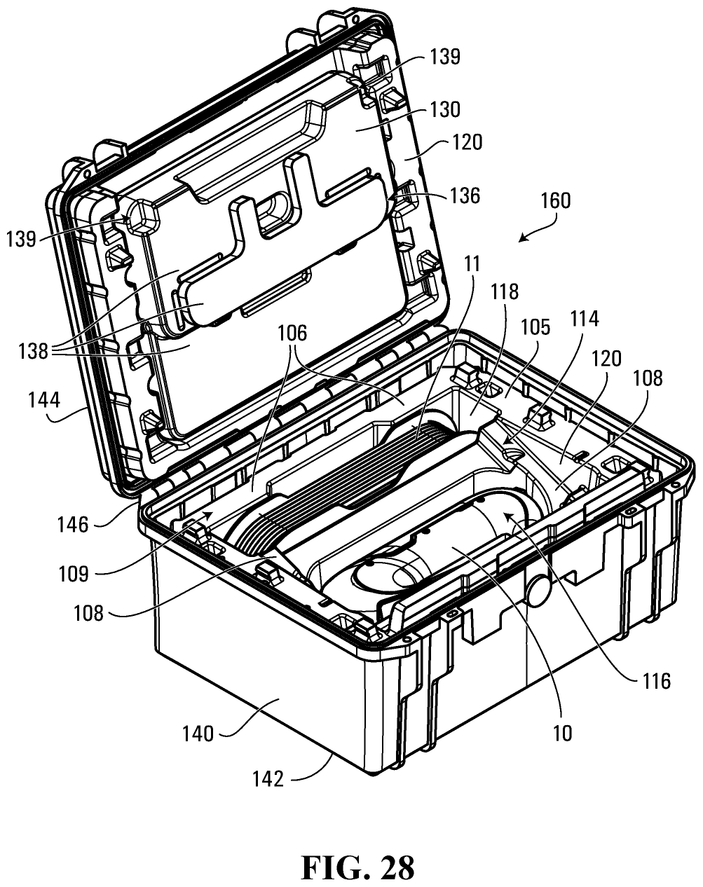

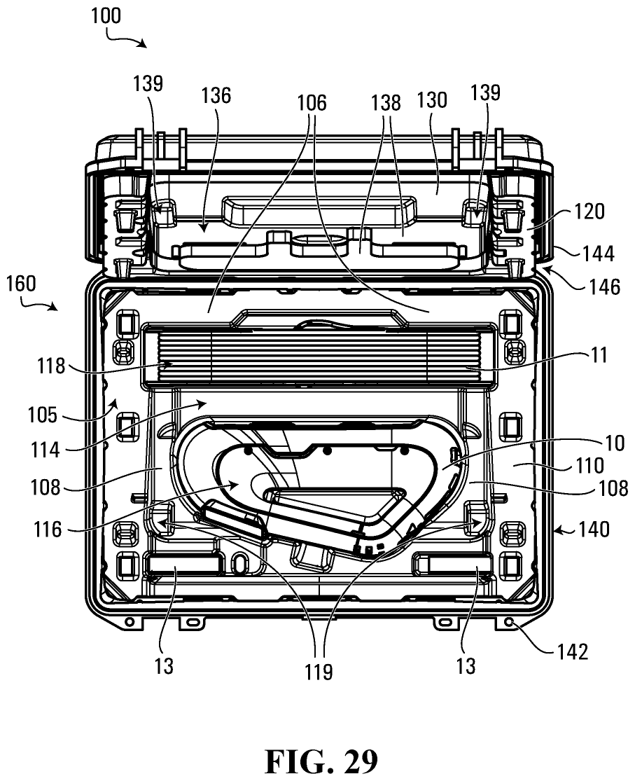

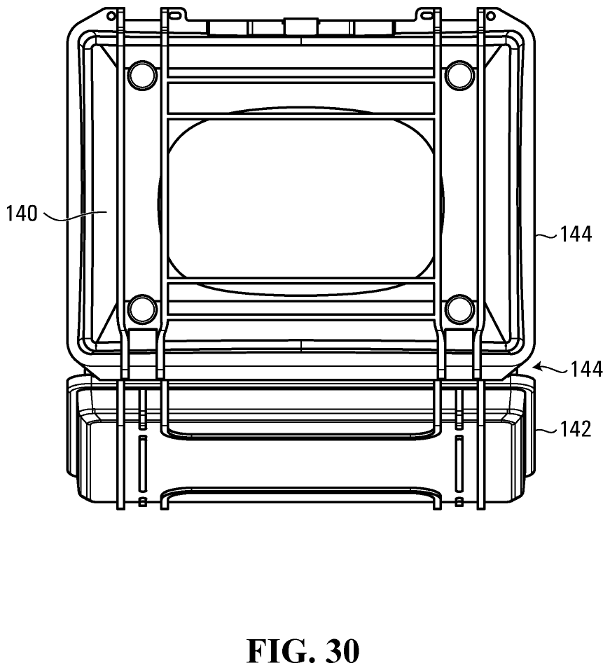

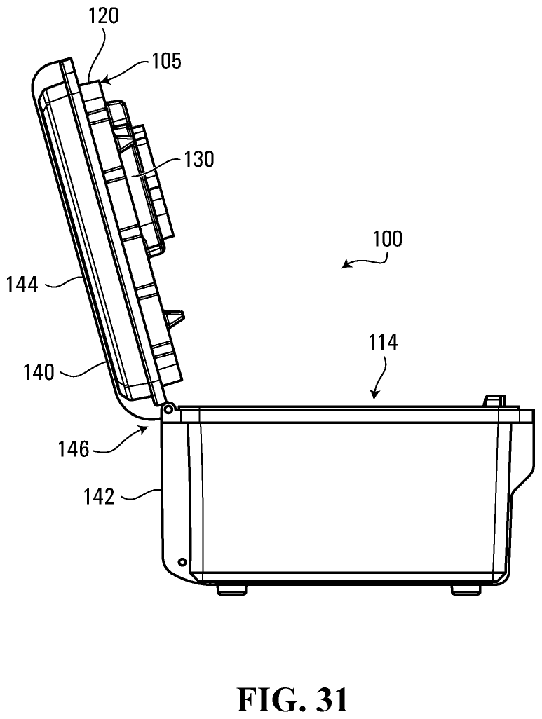

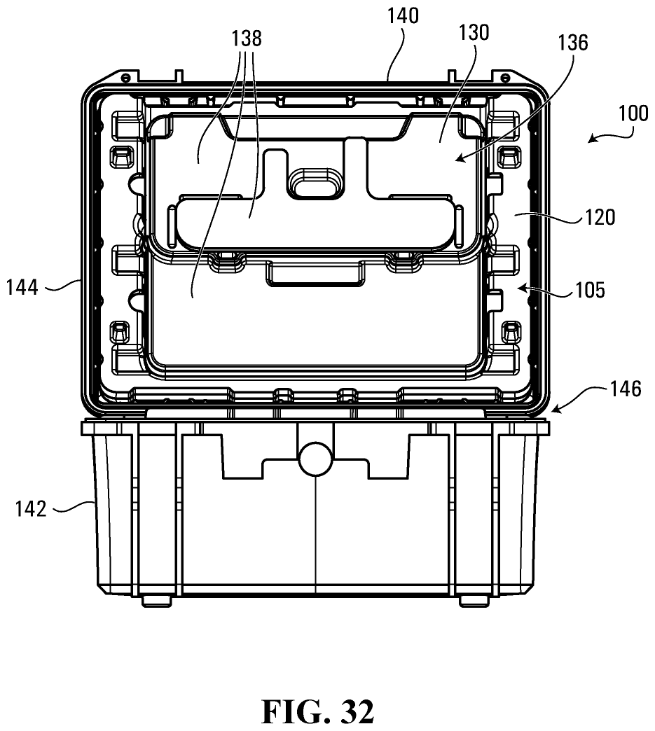

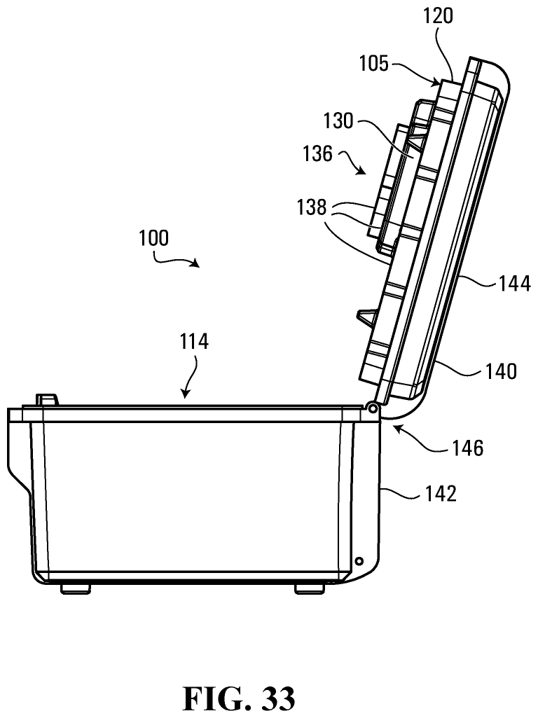

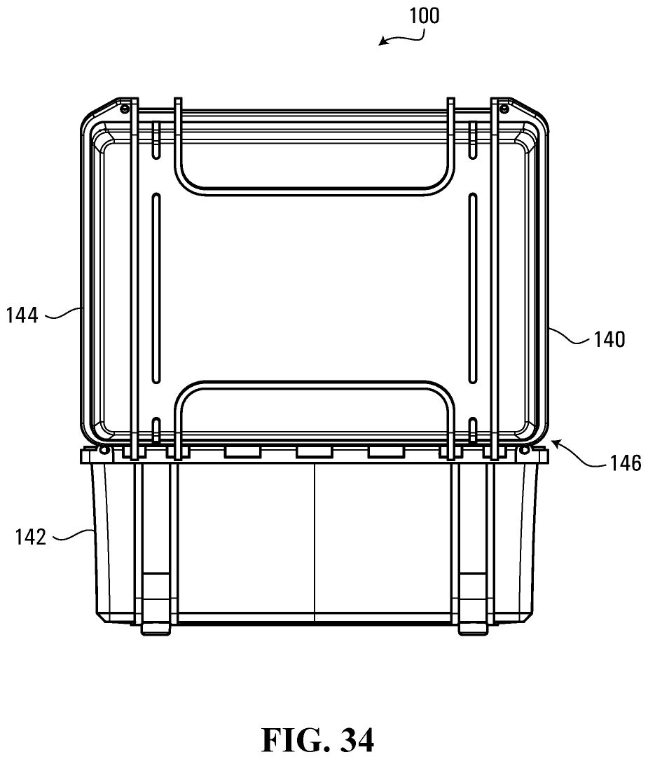

Optionally, in some embodiments, as illustrated in FIGS. 27 to 35, the carrying case system 100 may comprise an outer protective shell 140 including an upper outer shell 144 and a lower outer shell 142. The upper shell 144 and the lower shell 142 may define an internal space configured for holding therein the main body 105 of the carrying case system 100. The upper shell 144 may be configured to be at least partially releasably connected to the lower shell 142.

For example, the upper shell 144 may be hingedly connected to the lower shell 142. That is, the outer protective shell 140 may comprise one or more hinges 146 rotatably connecting the lower shell 142 to the upper shell 144. The outer shell 140 may be made of any suitable relatively rigid material. For example, the rigid material may be comprised of at least one of a hard plastic material and a metallic material.

Optionally, in some embodiments, the carrying case system 100 may comprise at least one wheel (not shown in the Figures) mounted to the outer protective shell 140 for facilitating displacements of the carrying case system 100.

Optionally still, in some embodiments, the carrying case system 100 may comprise at least one handle (not shown in the Figures) connected to the outer protective shell 140 for facilitating transport of the carrying case system 100 by a user.

### Alternative Configurations

While a detailed description of specific embodiments of a carrying case system and a calibration method using such a carrying case system have been presented in detail with reference to FIGS. 3 to 35, various alternative embodiments of carrying case systems and calibration methods may be contemplated and will become apparent to the person skilled in the art in view of the present disclosure.

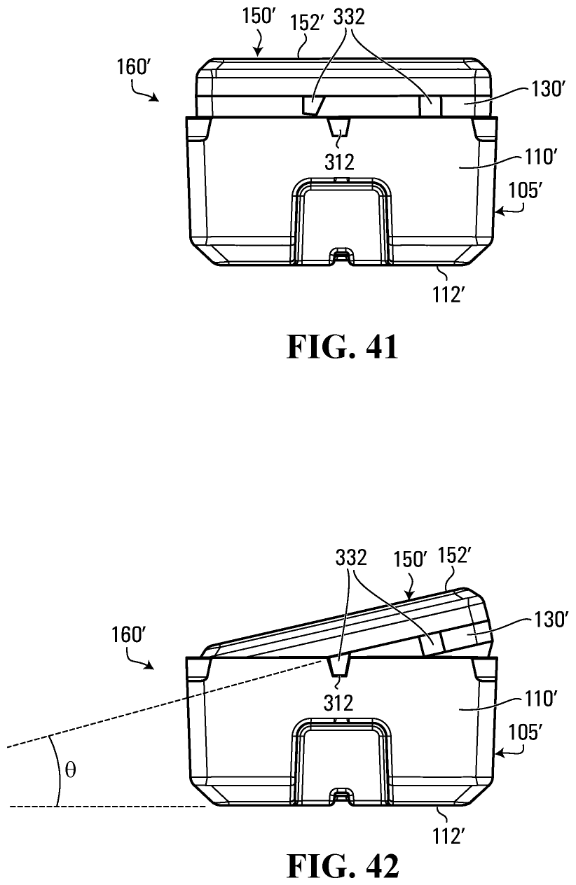

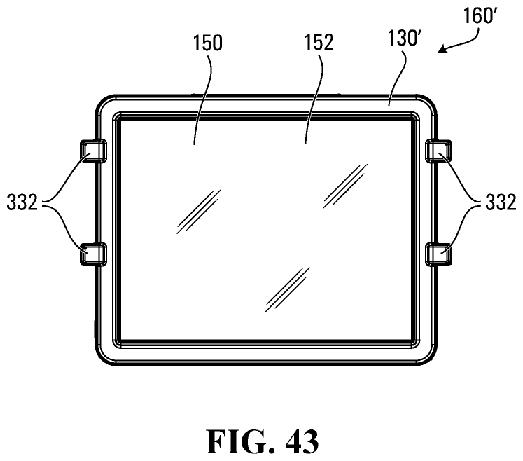

For instance, in a first variant as shown in FIGS. 41 to 43, the positioning system 160′ may include a first set of positioning elements 330 on the protective frame 130′ and a second set of positioning elements 310 on the main body 105′. More specifically, in this example, the second set of positioning elements 310 may be on the lower body member 110′ of the main body 105′. The second set of positioning elements 310 may be complementary to the first set of positioning elements 330. In particular, as shown in FIG. 41, the first set of positioning elements 330 may include a set of projections 332 disposed about a periphery of the protective frame 130′, and the second set of positioning elements 310 may include at least one set of notches 312 on the main body 105, the set of notches 312 being complementary to the set of projections 332 on the protective frame 130′. More specifically, in this embodiment, the set of notches may be positioned on a periphery of the lower member 130′. In this embodiment, in the first calibration position, the protective frame member 130 may rest on part of a periphery of the lower frame member 110′ such that the calibration surface 152′ is substantially parallel to the bottom surface 112′ of the main body 105′ supporting the main body 105′, as shown in FIG. 42. In this embodiment, the set of notches 312 may correspond to the second calibration position of the calibration plate 150. In the second calibration position, the set of notches may releasably engage the set of projections 332 disposed about the periphery of the protective frame 130′ so as to orient the calibration plate 150′ according to the second calibration position and define the angle 0 with the bottom surface 112′ of the main body 105′ supporting the carrying case system 105′, as shown in FIG. 43. Alternatively (not shown in the Figures), instead of, or in addition to, providing the second set of positioning elements 310 on the lower body member 110′, the second set of positioning elements 310 may be provided on the upper body member 120′ of the main body 105′.

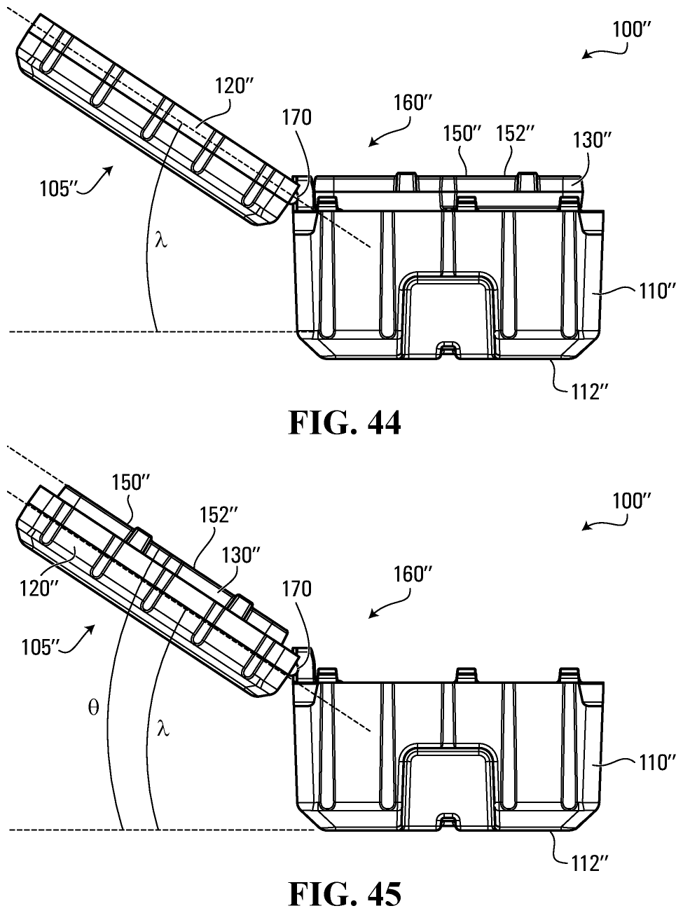

According to a second variant, of the type shown in FIGS. 44 and 45, the main body 105″ may comprise a hinge 170 connecting the lower member 110″ and the upper member 120″ of the main body 105″ such that the lower member 110″ and the upper member 120″ of the main body 105″ are hingedly connected to one another. In this embodiment, the hinge 170 may have an open configuration wherein an angle λ between the lower member 110″ and the upper member 120″ is predefined. In this embodiment, the positioning system 160″ is at least in part implemented by the lower member 110″, the upper member 120″ and the hinge 170 of the main body 105″. More specifically, in this embodiment, the upper member 120 ″ may define a cavity configured for receiving and releasably holding into place the second side 136″ of the protective frame member 130″. In each of the first and second calibration positions, the hinge 170 may be in an open configuration. In the first calibration position, the protective frame member 130″ may rest on part of a periphery of the lower member 110″ such that the calibration surface 152″ is substantially parallel to the bottom surface 112″ of the main body 105″ supporting the main body 105″, as shown in FIG. 44. In the second calibration position, the protective frame member 130″ may rest on the upper member 120″. More specifically, in the second position, the second side 136″ of the protective frame member 130″ may be received and releasably held into place by the cavity of the upper member 120″ and the predefined angle between the lower member 110″ and the upper member 120″ may define the angle 0 with the bottom surface 112″ of the main body 105″ supporting the carrying case system 105″, as shown in FIG. 45.

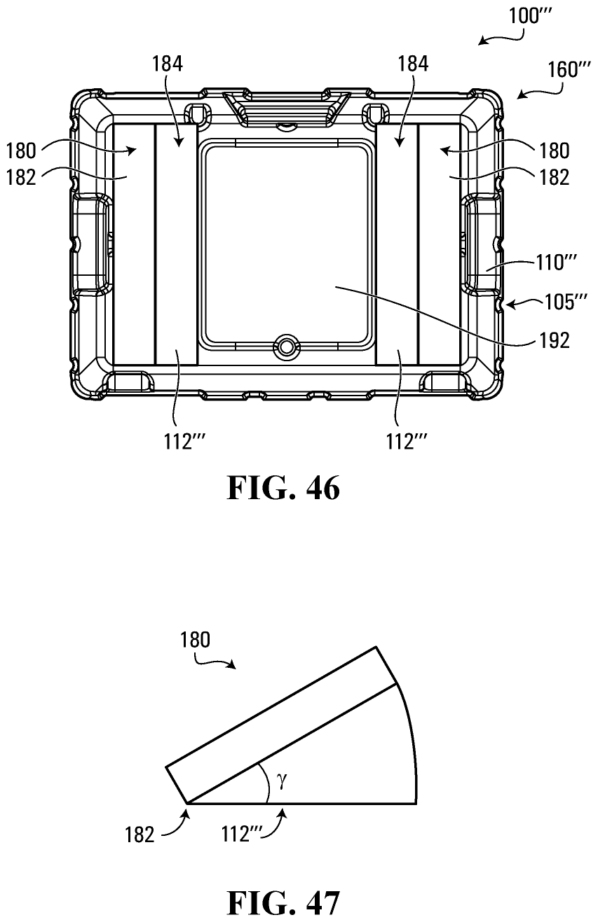

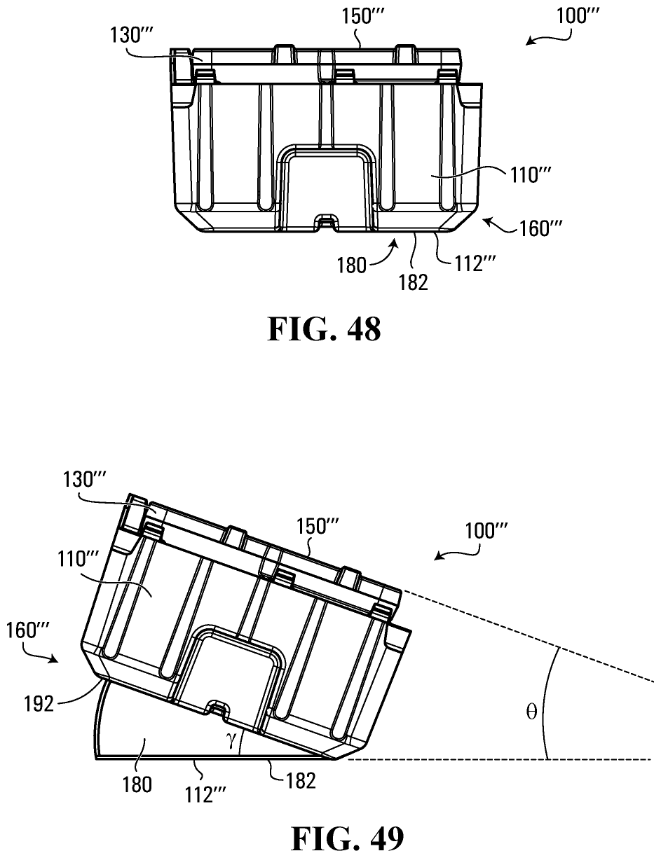

According to a third variant, of the type shown in FIGS. 46 to 49, the positioning system 160′″ may comprise at least one wedge 180 configured to define at least some of the calibration positions. In the specific embodiment depicted, the positioning system 160′″ comprises at least two wedges 180 and the main body 105′″ may comprise compartments for storing the wedges 180. In this embodiment, as shown in FIG. 46, the compartments may be provided on a bottom side of the lower member 110′″. In this embodiment, as shown in FIG. 47, each of the wedges 180 may define an angle y and may comprise a surface 182 which, in at least one configuration, may be configured for supporting the carrying case system 105′″. As such, in some configurations, the surface 182 may correspond to the bottom surface 112′″ of the main body 105′″ supporting the carrying case system 105′″. In the first calibration position, each of the hinges 180 may be held in their respective cavity of the main body 105, the protective frame member 130′″ may rest on part of a periphery of the lower member 110′″ such that the calibration surface 152′″ is substantially parallel to the bottom surface 112′″ of the main body 105′″ supporting the main body 105′″, as shown in FIG. 48. In the second calibration position, each of the wedges 180 may be withdrawn from their respective cavity of the main body 105′″ and may be placed on respective wedge-receiving surfaces 184 of the main body 105′″. In this example, the wedge-receiving surfaces 184 may be provided on a bottom surface of the lower member 120′″. In this embodiment, in the second calibration position, the protective frame member 130′″ may still rest on part of a periphery of the lower member 110′″, and the calibration surface 152′″ may be substantially parallel to a non-supporting bottom surface 112′″ of the lower member 110′″. Because of the angle γ of the wedges 180, in the second calibration position, the calibration surface 152′″ may define the angle θ with the bottom surface 112′″ supporting the carrying case system 105′″, as shown in FIG. 49.

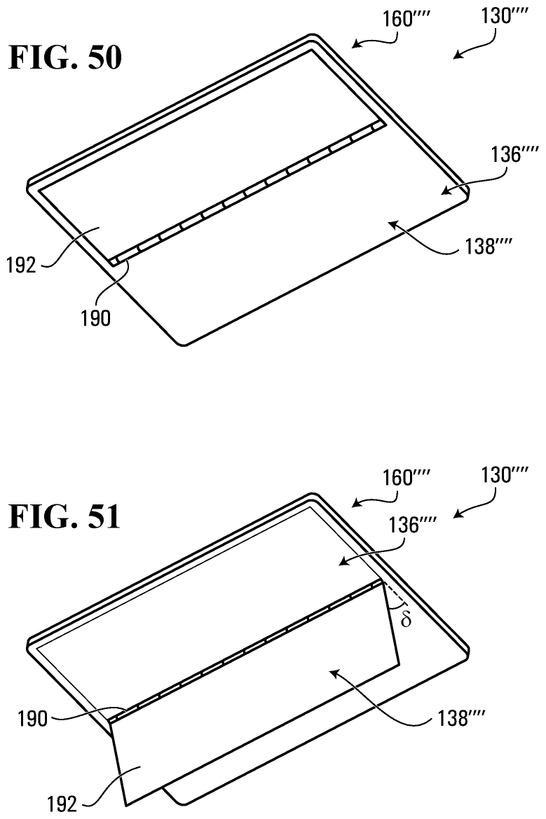

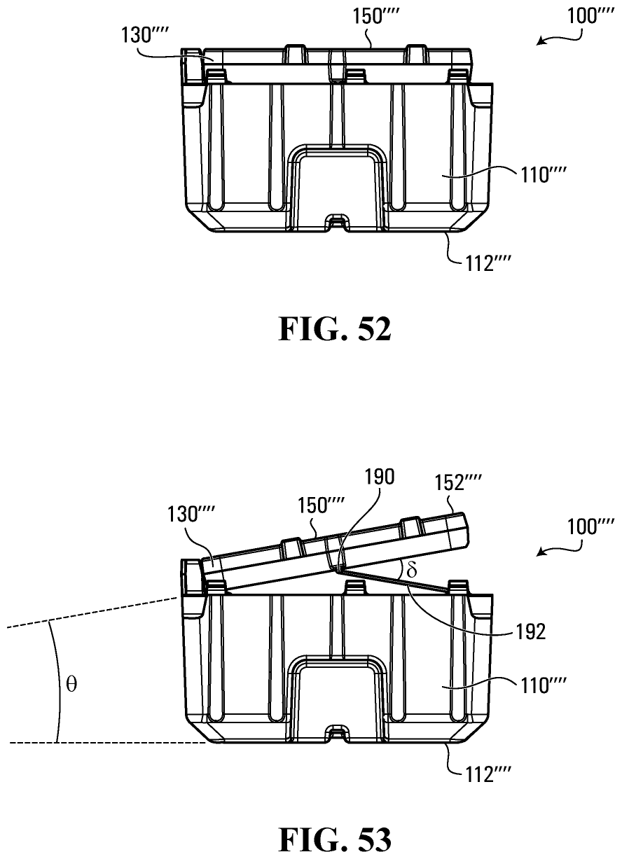

According to a fourth variant, as shown in FIGS. 50 to 53, the positioning system 160″″ may comprise a hinge 190 and a flap 192 on the second side 136″″ of the protective frame member 130″″. In this embodiment, the frame mounting surface 138″″ of the second side 136″″ of the protective frame member 130″″ is reconfigurable such that the protective frame member 130″″ can be selectively positioned on the lower member 110′″ of the main body 105″″ in a first calibration position and in a second calibration position. For instance, as shown in FIG. 50, in a first position, the flap 192 may be substantially flat with a remaining portion of the frame mounting surface 138″″ of the second side 136″″ of the protective frame member 130″″. In a second position, as shown in FIG. 51, the flap 192 may define an angleδ with the remaining portion of the frame mounting surface 138″″ of the second side 136″″ the protective frame member 130″″. In a first calibration position of the positioning system 160″″, the protective frame member 130″″ holding the calibration plate 150″″ and configured so that the flap 192 is positioned at the first position may rest on part of a periphery of the lower member 110″″, such that the calibration surface 152″″ is substantially parallel to the bottom surface 112″″ of the main body 105″″ supporting the main body 105″″, as shown in FIG. 52. In a second calibration position of the positioning system 160″″, the protective frame member 130″″ holding the calibration plate 150″″ and configured so that the flap 192 is positioned at the second position may rest on part of the periphery of the lower member 110″″, such that the calibration surface 152″″ may define the angle θ with the bottom surface 112″″ supporting the carrying case system 105″″, as shown in FIG. 53.

It will be appreciated that other approaches and configurations for providing carrying case systems for 3D scanners providing positioning systems configured for positioning calibration plates in two or more different calibration positions are possible and will become apparent to the person skilled in the art in view of the present disclosure.

In addition, although in the embodiments described above the plurality of different calibration positions comprise two different calibration positions, in some alternative embodiments, the plurality of different calibration positions may include at least three or more (e.g., at least four) different calibration positions.

In some embodiments, any feature of any embodiment described herein may be used in combination with any feature of any other embodiment described herein.

Certain additional elements that may be needed for operation of certain embodiments have not been described or illustrated as they are assumed to be within the purview of those of ordinary skill in the art. Moreover, certain embodiments may be free of, may lack and/or may function without any element that is not specifically disclosed herein.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps. As used in the present disclosure, the terms “around”, “about” or “approximately” shall generally mean within the error margin generally accepted in the art. Hence, numerical quantities given herein generally include such error margin such that the terms “around”, “about” or “approximately” can be inferred if not expressly stated.

In describing embodiments, specific terminology has been resorted to for the sake of description, but this is not intended to be limited to the specific terms so selected, and it is understood that each specific term comprises all equivalents. In case of any discrepancy, inconsistency, or other difference between terms used herein and terms used in any document incorporated by reference herein, meanings of the terms used herein are to prevail and be used.

Any references cited in the present specification is hereby incorporated by reference in its entirety for all purposes.

Although various embodiments of the disclosure have been described and illustrated, it will be apparent to those skilled in the art in light of the present description that numerous modifications and variations can be made. The scope of the invention is defined more particularly in the appended claims.

1. A carrying case system for a 3D scanner and a calibration plate, said carrying case system comprising:
a) a main body comprising a lower body member defining a space for holding the 3D scanner;
b) a protective frame member distinct from the lower body member of the main body for holding the calibration plate;
c) a positioning system configured for mounting the protective frame member to the main body of the carrying case system in a selected one of a plurality of different calibration positions, wherein the plurality of different calibration positions define respective inclination angles between the calibration plate and the main body, the plurality of different calibration positions including at least two distinct calibration positions for using the calibration plate during calibration of the 3D scanner.

2. A carrying case system as defined in claim 1, wherein the main body further comprises an upper body member distinct from the lower body member, wherein the upper body member and the lower body member are configured to releasably engage one another to define an internal storage space for holding the 3D scanner and the calibration plate.

3. A carrying case system as defined in claim 2, wherein the protective frame member is configured to be positioned within the internal storage space defined by the upper body member and the lower body member of the main body.

4. (canceled)

5. A carrying case system as defined in claim 2, wherein the internal storage space defined by the upper body member and the lower body member is a fully enclosed internal storage space.

6. A carrying case system as defined in claim 1, wherein the positioning system is configured for mounting the protective frame member to the lower body member of the main body in the selected one of the plurality of different calibration positions, wherein the respective inclination angles between the calibration plate and the main body corresponds to inclination angles between the calibration plate and the lower body member of the main body.

7. A carrying case system as defined in claim 2, wherein the positioning system is configured for mounting the protective frame member to the upper body member of the main body in the selected one of the plurality of different calibration positions, wherein the respective inclination angles between the calibration plate and the main body correspond to inclination angles between the calibration plate and the upper body member of the main body.

8. A carrying case system as defined in claim 6, wherein the positioning system includes:
a) a first positioning surface on the main body; and
b) a second positioning surface on the main body;
wherein the first positioning surface and the second positioning surface are nonparallel to one another.

9. A carrying case system as defined in claim 8, wherein the positioning system includes at least one frame mounting surface on the protective frame configured to engage a selected one of the first positioning surface and the second positioning surface.

10. (canceled)

11. (canceled)

12. A carrying case as defined in claim 9, wherein only one of the first positioning surface and the second positioning surface of the positioning system can be engaged at a given time by the at least one surface of the protective frame.

13. (canceled)

14. A carrying case system as defined in claim 8, wherein the first positioning surface corresponds to a first one the plurality of different calibration positions and the second positioning surface corresponds to a second one the plurality of different calibration positions.

15. A carrying case system as defined in claim 14, wherein each of the first positioning surface and the second positioning surface is oriented along a respective axis determining respective ones of the plurality of different calibration positions.

16. (canceled)

17. (canceled)

18. (canceled)

19. (cancelled)

20. (canceled)

21. (canceled)

22. A carrying case system as defined in claim 2, wherein the positioning system includes:
a) a first set of positioning elements on the protective frame;
b) a second set of positioning elements on the main body, the second set of positioning elements being complementary to the first set of positioning elements.

23. A carrying case system as defined in claim 22, wherein:
a) the first set of positioning elements on the protective frame form a frame mounting surface disposed about a periphery of the protective frame; and
b) the second set of positioning elements form at least two positioning surfaces on the main body, the at least two at least two positioning surfaces being complementary to the frame mounting surface on the protective frame, the at least two positioning surfaces including:
i) a first positioning surface corresponding to a first calibration position in the plurality of calibration positions, the first positioning surface being configured for releasably engaging the frame mounting surface disposed about the periphery of the protective frame so as to orient the calibration plate according to a first calibration position;
ii) a second positioning surface corresponding to a second calibration position in the plurality of calibration positions, the second positioning surface being configured for releasably engaging the frame mounting surface disposed about the periphery of the protective frame so as to orient the calibration plate according to the second calibration position.

24. A carrying case system as defined in claim 23, wherein the first positioning surface is positioned on at least one of: (i) the lower body of the frame; an inner periphery of the lower body of the frame; and an outer periphery of the lower body of the frame.

25. (canceled)

26. (canceled)

27. A carrying case system as defined in claim 24, wherein the second positioning surface is positioned on at least one of: the lower body of the frame; an inner periphery of the lower body of the frame; on the upper body of the frame; an inner periphery of the upper body of the frame and an outer periphery of the upper body of the frame.

28. (canceled)

29. (canceled)

30. (canceled)

31. (canceled)

32. A carrying case system as defined in claim 6, wherein the positioning system includes a hinged member disposed opposite a calibration surface of the calibration plate, said hinged member being extendible so as to position the calibration plate in a selected one of the plurality of different calibration positions, the hinged member being configured to be mounted on at least one of the lower body member and the upper body member.

33. A carrying case system as defined in claim 1, wherein the plurality of different calibration positions includes a first specific calibration position defining a first specific inclination angle between 10° and 70°.

34. A carrying case system as defined in claim 33, wherein the first specific inclination angle is between 15° and 60°.

35. (canceled)

36. (canceled)

37. (canceled)

38. A carrying case system as defined in claim 33, wherein the plurality of different calibration positions includes a second specific calibration position defining a second specific inclination angle between 0° and 45°.

39. (canceled)

40. (canceled)

41. A carrying case system as defined in claim 40, wherein the second specific inclination angle is about 0° so that the calibration plate is substantially co-planar with lower body member of the main body.

42. A carrying case system as defined in claim 1, wherein the plurality of different calibration positions includes three or more different calibration positions.

43. A carrying case system as defined in claim 1, wherein the positioning system is further configured for mounting the protective frame member to the lower body member of the main body in a storage position distinct from the calibration positions in the plurality of different calibration positions.

44. (canceled)

45. A carrying case system as defined in claim 43, wherein in the storage position, the protective frame is configured for holding the calibration plate in an orientation that is substantially co-planar with the lower body member.

46. A carrying case system as defined in claim 1, wherein the main body is comprised of a lightweight material including a foam, the foam being selected from the set consisting of expanded polystyrene (EPS) foam and Expanded Polypropylene (EPP) foam.

47. (canceled)

48. (canceled)

49. (canceled)

50. )canceled)

51. A carrying case system as defined in claim 1, said carrying case system comprising an outer protective shell made of a rigid material, the outer protective shell including an upper outer shell and a lower outer shell, wherein the upper shell is configured to be at least partially releasably connected to the lower shell, the upper shell and a lower shell defining an internal space configured for holding therein the main body of the carrying case system.

52. (canceled)

53. (canceled)

54. (canceled)

55. (canceled)

56. (canceled)

57. A carrying case system as defined in claim 1, wherein the space for holding the 3D scanner defined by the lower body member includes a cavity for holding the 3D scanner, the cavity being shaped to substantially match a shape of the 3D scanner.

58. A carrying case system as defined in claim 1, wherein the space for holding the 3D scanner defined by the lower body member includes a first cavity for holding the 3D scanner and a second cavity for holding cable components associated with the 3D scanner, wherein the cable components include at least one of a power cable and a data cable wherein:
a) the first cavity is shaped to substantially match a shape of the 3D scanner; and
b) the second cavity has an elongated shape for receiving the wiring components, the second cavity being distinct from the first cavity.

59. (canceled)

60. A carrying case system as defined in claim 1, wherein the 3D scanner is a handheld 3D scanner.

61. A carrying case system for a 3D scanner and a calibration plate, said carrying case system comprising:
a) a protective frame member for holding the calibration plate;
b) a main body comprising:
i) a lower body member defining a first cavity for holding the 3D scanner;
ii) an upper body member distinct from the lower body member, wherein the upper body member and the lower body member are configured to releasably engage one another to define an internal storage space;
wherein the protective frame member is configured to be positioned within the internal storage space defined by the upper body member and the lower body member of the main body.

62. A carrying case system as defined in claim 61, wherein the protective frame member is configured for lying above the first cavity defined by the lower body member.

63. A carrying case system as defined in claim 61, comprising a positioning system configured for mounting the protective frame member to the lower body member so that the calibration plate lies over the cavity defined by the lower body member.

64. A carrying case system as defined in claim 63, wherein the lower body member defines a second cavity for holding cable components associated with the 3D scanner, wherein the cable components include at least one of a power cable and a data cable.

65. (canceled)

66. (canceled)

67. (canceled)

68. (canceled)

69. (canceled)

70. (canceled)

71. (canceled)

72. A method for calibrating a handheld 3D scanner using a calibration plate and a carrying case system as defined in claim 1, said method comprising the steps of:
a) mounting the protective frame member holding the calibration plate to the main body of the carrying case system in a first calibration position defining a first inclination angle between the calibration plate and the main body;
b) using the handheld 3D scanner to perform a first scanning event of the calibration plate while the protective frame member holding the calibration plate is mounted in the first calibration position, the first scanning event including performing a first translation movement of the handheld 3D scanner to vary a distance between the handheld 3D scanner and the calibration plate;
c) mounting the protective frame member holding the calibration plate to the main body of the carrying case system in a second calibration position defining a second inclination angle between the calibration plate and the main body;
d) using the handheld 3D scanner to perform a second scanning event of the calibration plate while the protective frame member holding the calibration plate is mounted in the second calibration position, the second scanning event including performing a second translation movement of the handheld 3D scanner to vary a distance between the handheld 3D scanner and the calibration plate;
e) processing data obtained during the first scanning event and the second scanning event to calibrate the handheld 3D scanner.

73. A method as defined in claims 72, wherein:
a) a first scanning orientation relative to the main body of the carrying case system is associated with the first scanning event; and
b) a second scanning orientation relative to the main body of the carrying case system is associated with the second scanning event, wherein the first scanning orientation and the second scanning orientation relative to the main body of the carrying case system are substantially similar.

74. (canceled)

75. A method as defined in claims 73, further comprising:
using the handheld 3D scanner to perform a third scanning event of the calibration plate while the protective frame member holding the calibration plate is mounted in one of the first calibration position and the second calibration position, the third scanning event including performing a third translation movement of the handheld 3D scanner to vary the distance between the handheld 3D scanner and the calibration plate.

76. A method as defined in claims 73, further comprising: using the handheld 3D scanner to perform a third scanning event of the calibration plate
while the protective frame member holding the calibration plate is mounted in the first calibration position, the third scanning event including performing a third translation movement of the handheld 3D scanner to vary the distance between the handheld 3D scanner and the calibration plate; and
using the handheld 3D scanner to perform a fourth scanning event of the calibration plate while the protective frame member holding the calibration plate is mounted in the second calibration position, the fourth scanning event including performing a fourth translation movement of the handheld 3D scanner to vary the distance between the handheld 3D scanner and the calibration plate.
